(19) United States
(12) Patent Application Publication
(10) Pub. No.: US 2026/0178193 A1
(43) Pub. Date: Jun. 25, 2026

(54) SINGLE PASS FOOTPRINT COMPRESSION OPTIMIZATION

(71) Applicant: QUALCOMM Incorporated, San Diego, CA (US)

(72) Inventors: Andrew Edmund TURNER, San Diego, CA (US); Anirudh GHAYAL, Secunderabad (IN)

(21) Appl. No.: 18/999,689

(22) Filed: Dec. 23, 2024

(51) Int. Cl. G06F 3/06

(52) U.S. Cl. CPC G06F 3/0608; G06F 3/0644; G06F 3/0673

(57) ABSTRACT

Disclosed are techniques for memory footprint compression in a computing device. In an aspect, a memory footprint compression system of a computing device may receive a size of compressed data stored in at least one output buffer. The memory footprint compression system may identify a class size based on the size of the compressed data. The memory footprint compression system may identify an unused memory pointer for a first memory slab based on the class size, wherein the first memory slab is pre-allocated. The memory footprint compression system may identify a memory address to write the compressed data to, based on the unused memory pointer. The memory footprint compression system may send the memory address to a direct memory access module.

### BACKGROUND OF THE DISCLOSURE

Efficient use of memory resources is a vital aspect of implementing computing systems. ZRAM is a Linux kernel feature that compresses data in memory, allowing computing systems to use RAM more efficiently by reducing the need for disk-based swap space, thereby improving performance in memory-constrained environments. In computing systems implementing ZRAM, ZRAM hardening is important because it enhances the stability, security, and performance of memory compression systems in environments where memory is constrained. This leads to better memory utilization, reduced latency, and a more reliable computing system, particularly in embedded computing systems, IoT devices, and other resource-limited platforms.

ZRAM hardening currently uses a two pass approach to complete a compression operation. In a first pass, the computing system compresses data, determines a final size of the compressed data, and temporarily stores the compressed data in a memory. Once the size of the compressed data is known, a software module allocates a necessary amount of memory or storage space based on this determination. This ensures that the computing system has an exact amount of space required for the compressed data. In a second pass, the computing system retrieves the compressed data from the memory and copies the compressed data into the allocated space.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method performed by a memory footprint compression system of a computing device for writing compressed data to memory includes receiving a size of compressed data stored in at least one output buffer; identifying a class size based on the size of the compressed data; identifying an unused memory pointer for a first memory slab based on the class size, wherein the first memory slab is pre-allocated; identifying a memory address to write the compressed data to, based on the unused memory pointer; and sending the memory address to a direct memory access module.

In an aspect, a computing device having a memory footprint compression system includes one or more memories; and one or more processors communicatively coupled to the one or more memories, the one or more processors, either alone or in combination, configured to: receive a size of compressed data stored in at least one output buffer; identify a class size based on the size of the compressed data; identify an unused memory pointer for a first memory slab based on the class size, wherein the first memory slab is pre-allocated; identify a memory address to write the compressed data to, based on the unused memory pointer; and send the memory address to a direct memory access module.

Further aspects include a computing device including a memory and a processor configured to perform operations of any of the methods summarized above. Further aspects include a non-transitory processor system readable storage medium having stored thereon processor system executable software instructions configured to cause a processor to perform operations of any of the methods summarized above. Further aspects include a computing device having means for accomplishing functions of any of the methods summarized above.

Other objects and advantages associated with the aspects disclosed herein will be apparent to those skilled in the art based on the accompanying drawings and detailed description.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating an example computing device suitable for implementing various aspects.

FIG. 2 is a component block diagram illustrating an example processing system of the computing device configured for implementing a slab allocator module suitable for implementing various aspects.

FIG. 3 is a component block diagram illustrating an example memory allocator module of the computing device suitable for implementing various aspects.

FIG. 4 is a component block and flow diagram illustrating an example of a single pass memory footprint compression system in the computing device suitable for implementing various aspects.

FIGS. 5A and 5B are component block and flow diagrams illustrating an example of a single pass memory footprint compression system in the computing device suitable for implementing various aspects.

FIGS. 6A-6C are process flow diagrams illustrating example methods for pre-allocating memory for single pass memory footprint compression according to one or more aspects.

FIG. 7 is a process flow diagram illustrating an example method for pre-allocating memory for single pass memory footprint compression according to one or more aspects.

FIG. 8 is a process flow diagram illustrating an example method for single pass memory footprint compression according to one or more aspects.

FIGS. 9A and 9B are process flow diagrams illustrating example methods for single pass memory footprint compression according to one or more aspects.

FIG. 10 is a process flow diagram illustrating an example method for single pass memory footprint compression according to one or more aspects.

FIG. 11 is a process flow diagram illustrating an example method for single pass memory footprint compression according to one or more aspects.

FIG. 12 is a process flow diagram illustrating an example method for single pass memory footprint compression according to one or more aspects.

FIG. 13 illustrates an example method 1300 for single pass memory footprint compression according to one or more aspects.

FIG. 14 is a component block diagram illustrating an example mobile computing device suitable for implementing various aspects.

FIG. 15 is a component block diagram illustrating an example mobile computing device suitable for implementing various aspects.

FIG. 16 is a component block diagram illustrating an example server suitable for implementing various aspects.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various aspects include methods and computing devices implementing such methods of implementing single pass memory footprint compression. Aspects may include a slab allocator module configured to pre-allocate memory slabs for multiple class sizes for use in implementing single pass memory footprint compression, and providing pointers to the memory slabs to a memory allocator module. Aspects may include the memory allocator module configured to identify a memory write address of a memory slab for a class size based on compression information for compressed data and a pointer of the memory slab for the class size, and providing the memory write address to a direct memory access module. Aspects may include a compressor module configured to write compressed data to output buffers and send the compressed data information to the memory allocator module. Aspects may include the direct memory address module configured to receive the memory write address from the memory allocator module, retrieve the compressed data from the output buffers, and write the compressed data to a memory at the memory write address.

The term “computing device” is used herein to refer to stationary computing devices including personal computers, desktop computers, all in one computers, workstations, supercomputers, mainframe computers, embedded computers (such as in vehicles and other larger systems), computing systems within or configured for use in vehicles, servers, multimedia computers, and game consoles. The terms “computing device” and “mobile computing device” are used interchangeably herein to refer to any one or all of cellular telephones, smartphones, personal or mobile multi-media players, personal data assistants (PDAs), laptop computers, tablet computers, convertible laptops/tablets (2 in 1 computers), smartbooks, ultrabooks, netbooks, palm top computers, wireless electronic mail receivers, multimedia Internet-enabled cellular telephones, mobile gaming consoles, wireless gaming controllers, and computing systems embedded in vehicles that include a memory, and a programmable processor.

Various aspects are described in terms of code, e.g., processing system executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various aspects.

ZRAM hardening currently uses a two pass approach to complete a compression operation. In a first pass, a computing system compresses data, determines a final size of the compressed data, and temporarily stores the compressed data in a memory. Once the size of the compressed data is known, a software module allocates a necessary amount of memory or storage space based on this determination. This ensures that the computing system has an exact amount of space required for the compressed data. In a second pass, the computing system retrieves the compressed data from the memory and copies the compressed data into the allocated space.

The current ZRAM hardening schemes have overhead and storage requirements. The compressed data must be stored in the memory until the allocation of memory space is completed, which for many compressions increases the use of memory space. As a result, the software must schedule memory operations twice for each compression. Power overhead is incurred for writing the compressed data and then copying the compressed data to memory or lower-level cache. Power overhead is incurred for a CPU to schedule writing the compressed data and then copying the compressed data to memory or lower-level cache. The two pass approach for ZRAM hardening incurs area, material, power, performance, and financial costs for the required memory space to write the compressed data to memory temporarily and copy the compressed data to memory. The two pass approach for ZRAM hardening incurs power and performance costs for the required memory operations to write the compressed data to memory temporarily and copy the compressed data to memory.

Aspects include single pass data compression that reduces the costs of current ZRAM hardening schemes by foregoing the temporary storage of the compressed data to the memory prior to writing the compressed data to the allocated memory. In various aspects, memory slabs may be pre-allocated for multiple class sizes prior to data compression. References to pre-allocating memory slabs relate to a process of identifying and reserving amounts and/or locations of memory slabs in memory before the memory addresses are needed by a program or operation. This technique may enable sufficient memory availability for use, thereby improving performance and reducing delays associated with dynamic memory allocation during application execution. Pre-allocated memory slabs may be available for allocation for use in storing the compressed data. Compressed data may be written to output buffers rather than temporarily stored in memory, a memory write address may be identified for the compressed data, and the compressed data may be written to memory at the memory write address from the output buffers. Various aspects forego the need in current ZRAM hardening schemes to temporarily write the compressed data to memory to wait for memory space to be allocated for the compressed data and then to copy the compressed data from the memory to the allocated memory.

A slab allocator module may pre-allocate memory slabs for multiple class sizes for a memory. The class sizes may correspond to an amount of memory space that may be pre-allocated for the memory slabs. The slab allocator module may generate pointers for the pre-allocated memory slabs for the multiple class sizes, and send the pointers to a memory allocator for identifying memory write addresses for compressed data for implementing single pass memory footprint compression. The pointers may be pointers to locations in the memory where the pre-allocated memory slabs are stored.

In some aspects, the slab allocator may pre-allocate one memory slab for each of the multiple class sizes and generate pointers for each of the pre-allocated memory slabs. In some aspects, the slab allocator module may pre-allocate multiple memory slabs for each of the multiple class sizes. In some aspects, the slab allocator module may initially generate and send pointers for less than all of the pre-allocated multiple memory slabs for each of the multiple class sizes and subsequently generate and/or send pointers for at least one other of the pre-allocated multiple memory slabs for each of the multiple class sizes. In some aspects, the slab allocator module may initially generate and send pointers for all of the pre-allocated multiple memory slabs for each of the multiple class sizes.

In some aspects, the slab allocator may receive memory slab status data from the memory allocator. The memory slab status data may be configured to indicate to the slab allocator the usage data of at least one memory slab for at least one class size. The slab allocator may track the usage of the at least one memory slab for at least one class size. In some aspects, the slab allocator may use the memory slab status data to identify whether to pre-allocate at least one additional memory slab for at least one class size. The slab allocator may pre-allocate at least one additional memory slab for at least one class size. The slab allocator may generate and send pointers for the pre-allocated at least one additional memory slab for at least one class size to the memory allocator. In some aspects, the slab allocator may use the memory slab status data to identify whether to generate and/or send pointers for at least one pre-allocated memory slab for at least one class size for which pointers have not yet been generated and/or sent.

In some aspects, the slab allocator may use the memory slab status data to identify whether to continue single pass memory footprint compression. The memory slab status data may be configured to indicate to the slab allocator whether to continue or to not continue single pass memory footprint compression. In some aspects, a determination whether to continue single pass memory footprint compression may be based on available storage in memory for single pass memory footprint compression. In some aspects, a determination whether to continue single pass memory footprint compression may be based on time to access and write to at least one memory slab for at least one class size. In aspects in which the slab allocator identifies or determines to not continue single pass memory footprint compression, the slab allocator may write out compressed data to a memory for temporary storage. The memory may store the compressed data for implementation of the known two pass approach to complete the compression operation.

In some aspects, the slab allocator may send a memory slab release signal to the memory allocator. The memory slab release signal may be configured to indicate that the memory allocator should or can release, or no longer use the pointers for, at least one memory slab for at least one class size. In some aspects, the slab allocator may receive a signal from a client application requesting access compressed data stored in the at least one memory slab for the at least one class size, triggering the slab allocator to send the memory slab release signal. In some aspects, the slab allocator may send the memory slab release signal based on or in response to identifying that the at least one memory slab for the at least one class size is full.

In some aspects, the memory allocator may manage pointers for pre-allocated memory slabs for multiple class sizes. The memory allocator may receive pointers for pre-allocated memory slabs for multiple class sizes from the slab allocator. The memory allocator may store the pointers for pre-allocated memory slabs for multiple class sizes.

In some aspects, the memory allocator module may identify a memory write address for writing the compressed data to a memory. The allocator may receive compression information from a compressor relating to compressed data for writing to the memory. The compression information may include a size of the compressed data. The memory allocator may use the size of the compressed data to identify a class size for a memory slab to which to write the compressed data. The memory allocator may identify whether a pre-allocated memory slab for the class size is large enough to store the compressed data has sufficient unused space to store the data. A memory slab for the class size having sufficient space to store the data may be selected for storing the compressed data.

In some aspects, the memory allocator may retrieve a pointer for the memory slab for the class size and use the pointer and compressed data size to identify a memory write address for writing the compressed data to the memory slab for the class size. The memory allocator may find an address of a free space of the class size within the memory slab. The memory allocator may send to a direct memory access module a write memory data, including the memory write address and compression information, such as one or more output buffer identifiers at which the compressed data may be stored.

In some aspects, the memory allocator may track usage of the memory slabs for multiple class sizes. Based on the use of the pointers and/or the identified memory write addresses and the compressed data size, the memory allocator may identify which parts or how much of the memory slabs for multiple class sizes are used or remain unused. The memory allocator may generate and send memory slab status data to the slab allocator. In some aspects, memory slab status data may be configured to indicate to the slab allocator which parts or how much of the memory slabs for multiple class sizes are used or remain unused.

In some aspects, the memory allocator may use the memory slab status data to identify whether to request the slab allocator to pre-allocate at least one additional memory slab for at least one class size. The memory slab status data may be configured to indicate to the slab allocator that it should pre-allocate at least one additional memory slab for at least one class size. In some aspects, the memory allocator may use the information to identify whether to request the slab allocator module to generate and/or to send pointers for at least one pre-allocated memory slab for at least one class size for which pointers have not yet been generated and/or sent. The memory slab status data may be configured to indicate to the slab allocator that it should generate and/or send pointers for at least one pre-allocated memory slab for at least one class size for which pointers have not yet been generated and/or sent.

In some aspects, the memory allocator may use the memory slab status data to identify whether to request the slab allocator to not continue single pass memory footprint compression. In some aspects identifying whether to request the slab allocator module to not continue single pass memory footprint compression may be based on availability of at least one memory slab for at least one class size having sufficient space to store a compressed data. In circumstances in which no memory slab for at least one class size has sufficient space to store the compressed data, the memory allocator may request the slab allocator to not continue single pass memory footprint compression. In some aspects, identifying whether to request the slab allocator to not continue single pass memory footprint compression may be based on the time required to access and write to at least one memory slab for at least one class size to store compressed data. In circumstances in which time to access and to write to at least one memory slab for at least one class size may exceed a time threshold, the memory allocator may request that the slab allocator to not continue single pass memory footprint compression. The memory slab status data may be configured to indicate to the slab allocator that it should transition from single pass memory footprint compression to the known two pass approach to complete the compression operation.

In some aspects, the memory allocator may receive a memory slab release signal. In some aspects, the memory allocator may receive the memory slab release signal from the slab allocator. In some aspects, the memory allocator may receive the memory slab release signal from a client application or a component of a single pass memory footprint compression system as discussed further herein. The memory slab release signal may be configured to indicate to the memory allocator that it should or can release, or no longer use the pointers for, at least one memory slab for at least one class size. The memory allocator may respond to the memory slab release signal by removing or making unavailable the pointers for at least one memory slab for at least one class size.

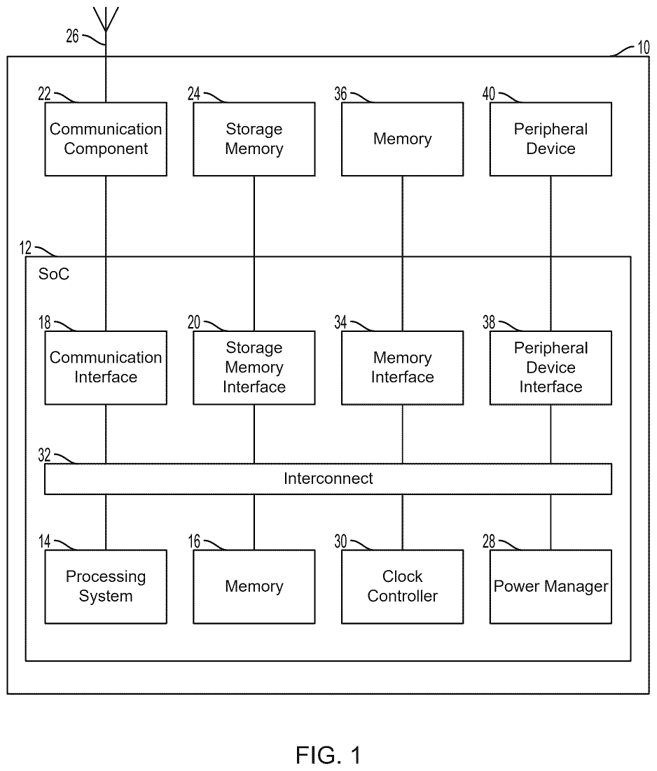

FIG. 1 illustrates a system including a computing device 10 suitable for use with various aspects. With reference to FIG. 1, the computing device 10 may include a system on chip (SoC) 12 with a processing system 14, a memory 16, a communication interface 18, a storage memory interface 20, a memory interface 34, a power manager 28, a clock controller 30, a peripheral device interface 38, and an interconnect 32. The computing device 10 may further include a communication component 22, such as a wired or wireless modem, a storage memory 24, an antenna 26 for establishing a wireless communication link, a memory 36, and a peripheral device 40. The processing system 14 may include any of a variety of processing devices, for example a number of processor cores.

The term “system on chip” (SoC) is used herein to refer to a set of interconnected electronic circuits typically, but not exclusively, including a processing device, a memory, and a communication interface. A processing system 14 may include a variety of different types of processors and processor cores, such as a general-purpose processor, a central processing unit (CPU), a digital signal processor (DSP), a graphics processing unit (GPU), an accelerated processing unit (APU), a secure processing unit (SPU), an artificial intelligence processing unit (AIPU), a subsystem processor of specific components of the computing device, such as an image processor for a camera subsystem or a display processor for a display, an auxiliary processor, a single core processor, a multicore processor, a controller, and a microcontroller. A processing system 14 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processing systems 14. The computing device 10 may include more than one SoC 12, thereby increasing the number of processing systems 14, processors, and processor cores. The computing device 10 may also include processing systems 14 that are not associated with an SoC 12. The processing systems 14 may each be configured for specific purposes that may be the same as or different from other processing systems 14 of the computing device 10. One or more of the processing systems 14, processors, or processor cores, of the same or different configurations may be grouped together. A group of processing systems 14, processors, or processor cores may be referred to as a multi-processor cluster.

The memory 16, 36 for the SoC 12 may be a volatile or nonvolatile memory configured for storing data and processing system executable code for access by the processing system 14. The computing device 10 and/or SoC 12 may include one or more memories 16, 36 configured for various purposes. One or more memories 16, 36 may include volatile memories such as random access memory (RAM) main memory, or cache memory. For example, the memories 16, 36 may include any of static RAM (SRAM), dynamic RAM (DRAM), etc. These memories 16, 36 may be configured to temporarily hold a limited amount of data received from a data sensor or subsystem, data and/or processing system executable code instructions that are requested from a nonvolatile memory 16, 24, loaded to the memories 16, 36 from the nonvolatile memory 16, 24 in anticipation of future access based on a variety of factors, and/or intermediary processing data and/or processing system executable code instructions produced by the processing system 14 and temporarily stored for future quick access without being stored in nonvolatile memory 16, 24. The memory 16, 36 may include multiple physical memory components, such as memory chips, that may be logically combined and/or separated to form the memory 16, 36. The memory interface 34 and the memory 36 may work in unison to allow the computing device 10 to load and retrieve data and processing system executable code on the memory 36.

The storage memory interface 20 and the storage memory 24 may work in unison to allow the computing device 10 to store data and processing system executable code on a nonvolatile storage medium. The storage memory 24 may be configured much like an aspect of the memory 16 in which the storage memory 24 may store the data or processing system executable code for access by one or more of the processing systems 14. The storage memory 24, being nonvolatile, may retain the information after the power of the computing device 10 has been shut off. When the power is turned back on and the computing device 10 reboots, the information stored on the storage memory 24 may be available to the computing device 10. The storage memory 24 may include multiple physical memory components, such as storage memory drives, chips, discs, etc., that may be logically combined and/or separated to form the storage memory 24. The storage memory interface 20 may control access to the storage memory 24 and allow the processing system 14 to read data from and write data to the storage memory 24.

The power manager 28 may be configured to control power states of one or more power rails (not shown) for power delivery to the components of the SoC 12. In some aspects, the power manager 28 may be configured to control amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

A peripheral device interface 38 may enable components of the SoC 12, such as the processing system 14 and/or the memory 16, to communicate with a peripheral device 40. The peripheral device interface 38 may provide and manage physical and logical connections between the components of the SoC 12 and the peripheral device 40. The peripheral device interface 38 may also manage communication between the components of the SoC 12 and the peripheral device 40, such as by directing and/or allowing communications between transmitter and receiver pairs of the components of the SoC 12 and the peripheral device 40 for a communication. The communications may include the transmission of memory access commands, addresses, data, interrupt signals, state signals, etc. A peripheral device 40 may be any component of the computing device 10 separate from the SoC 12, such as a processing system, a memory, a subsystem, etc. In some aspects, the peripheral device interface 38 may include a PCIe root complex and may enable PCIe protocol communication between the components of the SoC 12 and the peripheral device 40. In some aspects, the peripheral device 40 may be a component of the SoC 12.

The interconnect 32 may be a communication fabric, such as a communication bus, configured to communicatively connect the components of the SoC 12. The interconnect 32 may transmit signals between the components of the SoC 12. In some aspects, the interconnect 32 may be configured to control signals between the components of the SoC 12 by controlling the timing and/or transmission paths of the signals.

Some or all of the components, including components of the SoC 12, connected to the SoC 12, and the SoC 12, of the computing device 10 may be arranged differently, separated, and/or combined while still serving the functions of the various aspects. The computing device 10 may not be limited to one of each of the components, and multiple instances of each component may be included in various configurations of the computing device.

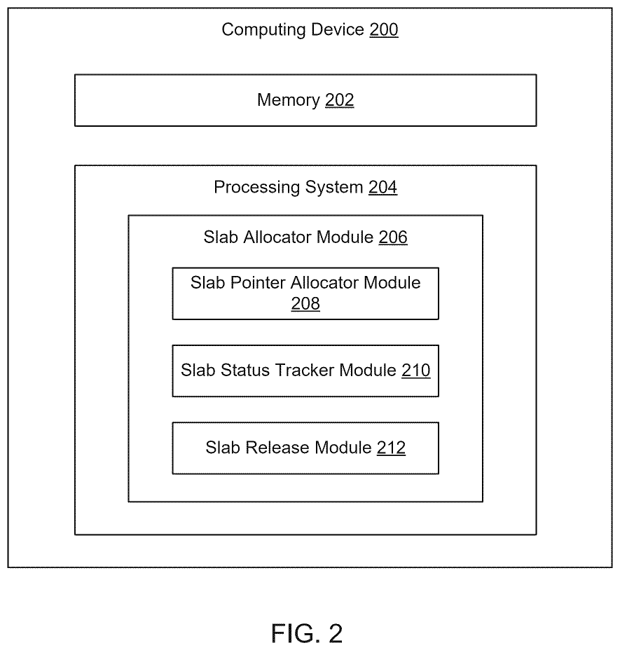

FIG. 2 illustrates a processing system 204 (e.g., processing system 14 in FIG. 1) of a computing device 200 (e.g., computing device 10 in FIG. 1) configured for implementing a slab allocator module 206 suitable for implementing various aspects. With reference to FIGS. 1 2, the slab allocator module 206 may be software having one or more modules 208 212 configured for implementing functions of the slab allocator module 206. The processing system 204 may be configured with processing system executable instructions of the one or more modules 208 212 for implementing functions of the one or more modules 208 212. The processing system 204 may be an integral component of the SoC (e.g., SoC 12 in FIG. 1) or other components (e.g., processing system 14, memory 16, communication interface 18, storage memory interface 20, memory interface 34, peripheral device interface 38, communication component 22, storage memory 24, memory 36, peripheral device 40 in FIG. 1) of the computing device. The computing device may include a memory 202 (e.g., memory 16, 36, storage memory 24 in FIG. 1) that may be a non-transitory processing system readable medium storing the processing system executable instructions of the one or more modules 208 212 for implementing functions of the one or more modules 208 212.

A slab pointer allocator module 208 of the slab allocator module 206 may be configured to pre-allocate memory slabs for multiple class sizes for the memory 202. The class sizes may correspond to an amount of the memory that may be pre-allocated for the memory slabs. For example, class sizes may range from 16 bytes to 2048 bytes. For example, the class sizes may be 16 byte aligned sizes, including, 16 bytes, 32 bytes, 48 bytes, etc. It may be understood by one skilled in the art that other class sizes aligned on a different basis are possible for different memories. For which of the various class sizes the slab pointer allocator module 208 may pre-allocate the memory slabs for the multiple class sizes may be statically preprogrammed or use case dependent dynamically determined.

The slab pointer allocator module 208 may generate pointers for the pre-allocated memory slabs for the multiple class sizes. The pointers may be pointers to locations in the memory 202 for the pre-allocated memory slabs. The slab pointer allocator module 208 may send the pointers to a memory allocator module for use in identifying memory write addresses for compressed data for implementing single pass memory footprint compression.

In some aspects, the slab pointer allocator module 208 may pre-allocate one memory slab for each of the multiple class sizes and generate pointers for each of the pre-allocated memory slabs. In some aspects, the slab pointer allocator module 208 may pre-allocate multiple memory slabs for each of the multiple class sizes. In some aspects, the slab pointer allocator module 208 may initially generate and send pointers for less than all of the pre-allocated multiple memory slabs for each of the multiple class sizes, including as few as one of the pre-allocated multiple memory slabs for each of the multiple class sizes. The slab pointer allocator module 208 may subsequently generate and/or send pointers for at least one other of the pre-allocated multiple memory slabs for each of the multiple class sizes. In some aspects, the slab pointer allocator module 208 may initially generate and send pointers for all of the pre-allocated multiple memory slabs for each of the multiple class sizes.

A slab status tracker module 210 of the slab allocator module 206 may be configured to receive memory slab status data from the memory allocator module. The memory slab status data may be configured to indicate to the slab status tracker module 210 which parts or how much of at least one memory slab for at least one class size are used or remain unused. The slab status tracker module 210 may track which parts or how much of at least one memory slab for at least one class size are used or remain unused.

In some aspects, the slab status tracker module 210 may use the memory slab status data to identify whether to pre-allocate at least one additional memory slab for at least one class size. Identifying whether to pre-allocate at least one additional memory slab for at least one class size may be based on a slab usage threshold of an amount of used or unused space of a memory slab for a class size. For example, the slab usage threshold may be all or less than all of the space of the memory slab for the class size being used or none of more than none of the space being unused. In some aspects, the slab status tracker module 210 may trigger the slab pointer allocator module 208 to pre-allocate at least one additional memory slab for at least one class size based on a comparison of memory slab status data to the slab usage threshold. The slab pointer allocator module 208 may generate and send pointers for the pre-allocated at least one additional memory slab for at least one class size to the memory allocator module.

In some aspects, the slab status tracker module 210 may use the memory slab status data to identify whether to generate and/or send pointers for at least one pre-allocated memory slab for at least one class size for which pointers have not yet been generated and/or sent. Identifying whether to generate and/or send pointers for at least one pre-allocated memory slab for at least one class size for which pointers have not yet been generated and/or sent may be based on the slab usage threshold. In some aspects, the slab status tracker module 210 may trigger the slab pointer allocator module 208 to generate and/or send pointers for at least one pre-allocated memory slab for at least one class size for which pointers have not yet been generated and/or sent based on a comparison of memory slab status data to the slab usage threshold.

In some aspects, the memory slab status data may be configured to indicate to the slab status tracker module 210 to trigger the slab pointer allocator module 208 to pre-allocate at least one additional memory slab for at least one class size. In some aspects, the memory slab status data may be configured to indicate to the slab status tracker module 210 to trigger the slab pointer allocator module 208 to generate and/or send pointers for at least one pre-allocated memory slab for at least one class size for which pointers have not yet been generated and/or sent.

In some aspects, in response to a trigger from the slab status tracker module 210, the slab pointer allocator module 208 may pre-allocate at least one additional memory slab for at least one class size. The slab pointer allocator module 208 may generate and send pointers for the pre-allocated at least one additional memory slab for at least one class size to the memory allocator module. In some aspects, in response to a trigger from the slab status tracker module 210, the slab pointer allocator module 208 may generate and/or send pointers for at least one pre-allocated memory slab for at least one class size for which pointers have not yet been generated and/or sent.

In some aspects, the slab status tracker module 210 may use the memory slab status data to identify whether to continue single pass memory footprint compression. The memory slab status data may be configured to indicate to the slab status tracker module 210 that it should continue or discontinue single pass memory footprint compression. The slab status tracker module 210 may interpret the memory slab status to identify whether to continue single pass memory footprint compression. In some aspects, a determination whether to continue single pass memory footprint compression may be based on available storage for single pass memory footprint compression. For example, the slab status tracker module 210 may not continue single pass memory footprint compression in response to the memory slab status data indicating to the slab status tracker module 210 that no memory slab for at least one class size has sufficient space to store the compressed data. In some aspects, a determination whether to continue single pass memory footprint compression may be based on time to access to write to at least one memory slab for at least one class size. For example, the slab status tracker module 210 may not continue single pass memory footprint compression in response to the memory slab status data indicating to the slab status tracker module 210 that time to access and write to at least one allocated memory slab for at least one class size may exceeds the time threshold.

In aspects in which the slab status tracker module 210 determines to not continue single pass memory footprint compression, the slab status tracker module 210 may write out compressed data to the memory 202 for temporary storage. The slab status tracker module 210 may generate and send a compressed data write out signal to one or more compressors. The compressed data write out signal may be configured to trigger the one or more compressors to write out the compressed data to the memory 202. The one or more compressors may write out the compressed data stored in one or more output buffers to the memory 202. The one or more compressors may also write out subsequent compressed data that is compressed by the one or more compressors to the memory 202. The one or more compressors may \write out the subsequent compressed data to the memory 202 directly, via the one or more output buffers, or another path. The memory 202 may store the compressed data for implementation of the known two pass approach to complete the compression operation. The memory 202 may store the compressed data for implementation of the known two pass approach to complete the compression operation.

A slab release module 212 of the slab allocator module 206 may be configured to send a memory slab release signal to the memory allocator module. The memory slab release signal may be configured to indicate to the memory allocator module to release, or no longer use the pointers for, at least one memory slab for at least one class size. In some aspects, the slab release module 212 may receive a signal from a client application wanting to access compressed data stored in the memory 202 in the at least one memory slab for the at least one class size, triggering the slab release module 212 to send the memory slab release signal. In some aspects, the slab release module 212 may receive a signal from the slab status tracker module 210, based on identification that the at least one memory slab for the at least one class size is full, triggering the slab release module 212 to send the memory slab release signal.

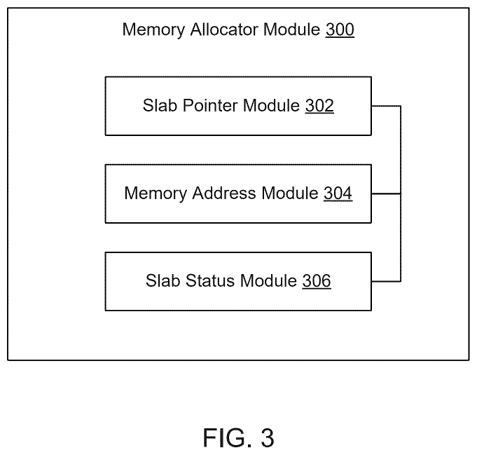

FIG. 3 illustrates a memory allocator module 300 of the computing device (e.g., computing device 10 in FIG. 1) suitable for implementing various aspects. With reference to FIGS. 1-3, the memory allocator module 300 may be an integrated circuit having one or more modules 302 306 including interconnected semiconductor components configured to implement functions of the one or more modules 302 306. One or more memory allocator modules 300 may be integral components of the SoC (e.g., SoC 12 in FIG. 1) or other components (e.g., processing system 14, memory 16, communication interface 18, storage memory interface 20, memory interface 34, peripheral device interface 38, communication component 22, storage memory 24, memory 36, peripheral device 40 in FIG. 1) of the computing device.

A slab pointer module 302 of the memory allocator module 300 may be configured to manage pointers for pre-allocated memory slabs for multiple class sizes. The slab pointer module 302 may receive pointers for pre-allocated memory slabs for multiple class sizes from the slab allocator module (e.g., the slab allocator module 206 in FIG. 2). The slab pointer module 302 may store the pointers for pre-allocated memory slabs for multiple class sizes. For example, the slab pointer module 302 may store the pointers for pre-allocated memory slabs for multiple class sizes in registers or buffers associated with the pre-allocated memory slabs for multiple class sizes. As another example, the slab pointer module 302 may store the pointers for pre-allocated memory slabs for multiple class sizes as slab pointer data structures, such as arrays, link lists, etc. In examples where a single memory slab is initially pre-allocated for each of the multiple class sizes, a single slab pointer data structure for each of the multiple class sizes may be used to store pointers for a corresponding memory slab for a class size. In examples where multiple memory slabs are initially pre-allocated for each of the multiple class sizes, multiple slab pointer data structures for each of the multiple class sizes may be used to store pointers for corresponding memory slabs of a class size.

In some aspects, the slab pointer module 302 may be configured to receive a memory slab release signal. In some aspects, the slab pointer module 302 may receive the memory slab release signal from the slab allocator module 206. In some aspects, the slab pointer module 302 may receive the memory slab release signal from a client application or a component of a single pass memory footprint compression system discussed further herein. The memory slab release signal may be configured to indicate to the slab pointer module 302 to release, or no longer use the pointers for, at least one memory slab for at least one class size. The slab pointer module 302 may respond to the memory slab release signal by removing or making unavailable the pointers for at least one memory slab for at least one class size.

A memory address module 304 of the memory allocator module 300 may be configured to identify a memory write address for writing the compressed data to a memory (e.g., memory 16, 36, storage memory 24, memory 202 in FIGS. 1 and 2). The memory address module 304 may receive compression information from a compressor relating to compressed data for writing to the memory. The compression information may include a size of the compressed data. The memory address module 304 may use the size of the compressed data to identify a class size for a memory slab to which to write the compressed data. For example, the compressed data size may be compared to one or more class sizes for one or more memory slabs by the memory address module 304. Comparison of the compressed data size to the one or more class sizes for one or more memory slabs may result in identifying which class size is greater than and closest to or equal to the compressed data size. The memory slab for the class size for which the class size is greater than and closest to or equal to the compressed data size may be large enough to store the compressed data. For another example, the class sizes may be equally spaced and the class size for a memory slab or a specific memory slab to which to write the compressed data may be identified from a direct calculation of the memory slab. In some aspects, identifying a class size for a memory slab to which to write the compressed data may include selecting an “off target” memory slab to target efficiency over memory savings. An off target slab may be a memory that may be a of a class size other than the class size that most closely fits the compressed data size.

The memory address module 304 may identify whether a pre-allocated memory slab for the class size large enough to store the compressed data has sufficient unused space to store the data. An amount of unused space of a pre-allocated memory slab for the class size may be identified based on slab status data generated by the slab status module 306 of the memory allocator module 300 described further herein. A memory slab for the class size having sufficient space to store the data may be selected for storing the compressed data.

The memory address module 304 may retrieve a pointer for the memory slab for the class size and use the pointer and compressed data size to identify a memory write address for writing the compressed data to the memory slab for the class size. The memory address module 304 may find an address within the memory slab of a free space of the class size. For example, the memory address module 304 may progressively fill the memory slab from a first free slot until the memory slab is full. Addresses in the memory slab may be calculated based on offset plus class size times allocation number. In some examples, a memory slab metadata may be updated to indicate use of the space in the memory slab. For example, the memory slab metadata may include a free list which may be empty for a full memory slab, which may not need updating unless releasing before full). For another example, the memory slab metadata may be incrementally updated. For further example, the memory address module 304 may search for a free slot within the memory slab. In some examples, searching for the free slot may be based on use of the memory slab metadata. The memory address module 304 may send a write memory data, including the memory write address and compression information, such as one or more output buffer identifiers at which the compressed data may be stored, to a direct memory access module.

The slab status module 306 of the memory allocator module 300 may be configured to track usage of the memory slabs for multiple class sizes. Based on the use of the pointers and/or the identified memory write addresses and the compressed data size, the slab status module 306 may identify which parts or how much of the memory slabs for multiple class sizes are used or remain unused. The slab status module 306 may generate and send memory slab status data to the slab allocator module 206. In some aspects, memory slab status data may be configured to indicate to the slab allocator module 206 which parts or how much of the memory slabs for multiple class sizes are used or remain unused.

In some aspects, the slab status module 306 may use the information of which parts or how much of the memory slabs for multiple class sizes are used or remain unused to identify whether to request the slab allocator module 206 to pre-allocate at least one additional memory slab for at least one class size. Identifying whether to request the slab allocator module 206 to pre-allocate at least one additional memory slab for at least one class size may be based on a slab usage threshold of an amount of used or unused space of a memory slab for a class size. For example, the slab usage threshold may be all or less than all of the space of the memory slab for the class size being used or none of more than none of the space being unused. In some aspects, the slab status module 306 may request the slab allocator module 206 to pre-allocate at least one additional memory slab for at least one class size based on a comparison of which parts or how much of the memory slabs for multiple class sizes are used or remain unused to the slab usage threshold. The memory slab status data may be configured to indicate to the slab allocator module 206 that it should pre-allocate at least one additional memory slab for at least one class size.

In some aspects, the slab status module 306 may use the information of which parts or how much of the memory slabs for multiple class sizes are used or remain unused to identify whether to request the slab allocator module 206 generate and/or send pointers for at least one pre-allocated memory slab for at least one class size for which pointers have not yet been generated and/or sent. Identifying whether to request the slab allocator module 206 to generate and/or send pointers for at least one pre-allocated memory slab for at least one class size for which pointers have not yet been generated and/or sent may be based on the slab usage threshold. In some aspects, the slab status module 306 may request the slab allocator module 206 to generate and/or send pointers for at least one pre-allocated memory slab for at least one class size for which pointers have not yet been generated and/or sent based on a comparison of which parts or how much of the memory slabs for multiple class sizes are used or remain unused to the slab usage threshold. The memory slab status data may be configured to indicate to the slab allocator module 206 that it should generate and/or send pointers for at least one pre-allocated memory slab for at least one class size for which pointers have not yet been generated and/or sent.

In some aspects, the slab status module 306 may use the information regarding which parts or how much of the memory slabs for multiple class sizes are used or remain unused to determine whether to request the slab allocator module 206 to not continue single pass memory footprint compression. In some aspects a determination whether to request the slab allocator module 206 to not continue single pass memory footprint compression may be based on availability of at least one memory slab for at least one class size having sufficient space to store compressed data. In circumstances in which no memory slab for at least one class size has sufficient space to store the compressed data, the slab status module 306 may request that the slab allocator module 206 not continue single pass memory footprint compression. The memory slab status data may be configured to indicate to the slab allocator module 206 that it should transition from single pass memory footprint compression to the known two pass approach to complete the compression operation. In some aspects, a determination whether to request the slab allocator module 206 to not continue single pass memory footprint compression may be based on time to access and write to at least one memory slab for at least one class size to store a compressed data. In circumstances in which time to access and write to at least one memory slab for at least one class size may exceed a time threshold, the slab status module 306 may request that the slab allocator module 206 not continue single pass memory footprint compression. The memory slab status data may be configured to indicate to the slab allocator module 206 that it should transition from single pass memory footprint compression to the known two pass approach to complete the compression operation.

In some aspects, the slab allocator module 206 and the one or more modules 208 212, described with refence to FIG. 2 may be alternately implemented as an integrated circuit including interconnected semiconductor components configured to implement functions of the one or more modules 208 212. In some aspects, the slab allocator module 206 and the one or more modules 208 212 may be alternately implemented as a combination of software and integrated circuit.

In some aspects, the memory allocator module 300 and the one or more modules 302 306, described with reference to FIG. 3, may be implemented as configured for implementing functions of the memory allocator module 300. The processing system 204 may be configured with processing system executable instructions of the one or more modules 302 306 for implementing functions of the one or more modules 302 306. In some aspects, the memory allocator module 300 and the one or more modules 302 306 may be alternately implemented as a combination of software and integrated circuit.

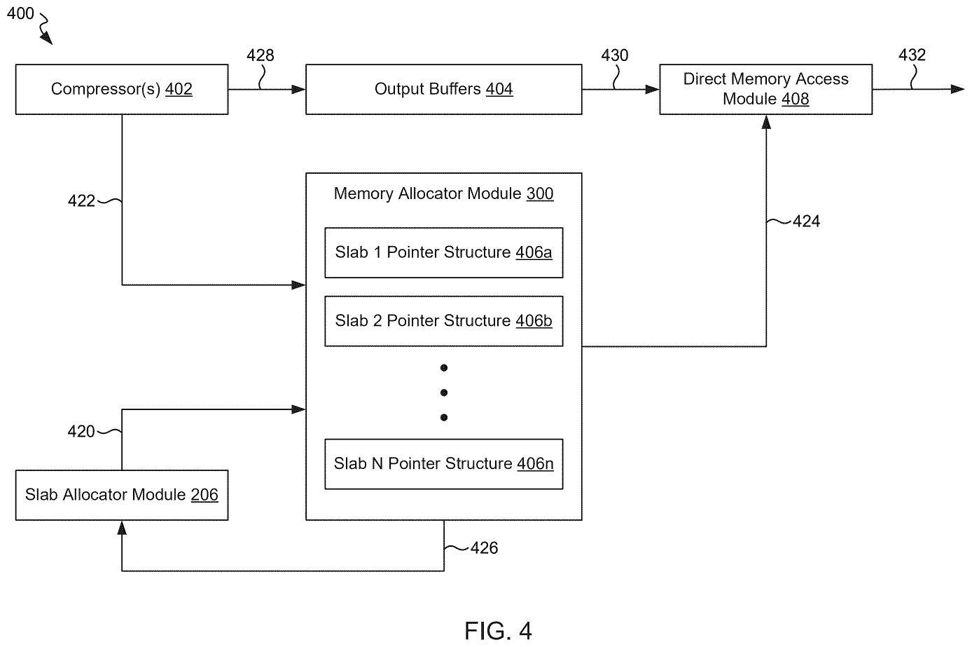

FIG. 4 illustrates an example of a single pass memory footprint compression system 400 in the computing device (e.g., computing device 10, 200 in FIGS. 1 and 2) suitable for implementing various aspects. With reference to FIGS. 1 4, the single pass memory footprint compression system 400 may include one or more compressors 402, one or more output buffers 404, the slab allocator module 206, the memory allocator module 300, and a direct memory access module 408. The components single pass memory footprint compression system 400 may be connected to and transmit signals between each other via one or more interconnects (e.g., interconnect 32 in FIG. 1).

The slab allocator module 206 may be connected to the memory allocator module 300. The slab allocator module 206 may pre-allocate at least one memory slab for multiple class sizes and initially send pointers for at least one pre-allocated memory slab for multiple class sizes via one or more signals 420 to the memory allocator module 300. In some aspects, the slab allocator module 206 may subsequently send pointers for at least one pre-allocated memory slab for at least one class size via the one or more signals 420 to the memory allocator module 300. In some aspects, the slab allocator module 206 may also send memory slab release signals via the one or more signals 420 to the memory allocator module 300.

The one or more compressors 402 may be connected to the one or more output buffers 404 and to the memory allocator module 300. The one or more compressors 402 may receive and compress data, generating compressed data. The one or more compressors 402 may write the compressed data to the one or more output buffers via one or more signals 428. Compression information may also be generated by the one or more compressors 402 for the compressed data. The compression information may include information regarding the compressed data, such as a compressed data size, identifiers of the one or more output buffers 404 on which the compressed data is stored, etc. The one or more compressors 402 may send the compression information to the memory allocator module 300 via one or more signals 422.

The memory allocator module 300 may be connected to the one or more compressors 402, the slab allocator module 206, and the direct memory access module 408. The memory allocator module 300 may receive the pointers for the pre-allocated memory slabs for the class sizes from the slab allocator module 206 via the one or more signals 420 and store the pointers in slab pointer structures 406a, 406b, 406n. The number, “N”, of slab pointer structures 406a, 406b, 406n may correspond to the number of class sizes for the memory slabs. For example, each slab pointer structure 406a, 406b, 406n may be configured to store the pointers for a pre-allocated memory slab for a class size. The slab pointer structures 406a, 406b, 406n may be physical memory components, such as registers, buffers, etc., configured to store the pointers for the pre-allocated memory slabs for the class sizes in data structures, such as arrays, linked lists, etc.

The memory allocator module 300 receives the compression information for compressed data in the one or more output buffers 404 from the one or more compressors 402 via the one or more signals 422. Based on the compression information, such as the compressed data size, and the pointers for a pre-allocated memory slab for a class size in which the compressed data may be stored, the memory allocator module 300 may generate a memory write address for the compressed data. The memory allocator module 300 may send a write memory data, including the memory write address and compression information, such as the one or more identifiers of the one or more output buffers 404 on which the compressed data is stored and/or the compressed data size, to the direct memory access module 408 via one or more signals 424.

The memory allocator module 300 may send memory slab status data to the slab allocator module 206 via one or more signals 426. The memory slab status data may be configured to indicate to the slab allocator module 206 which parts or how much of at least one memory slab for at least one class size are used or remain unused. In some aspects, the memory slab status data may be configured to indicate to the slab allocator module 206 to pre-allocate at least one additional memory slab for at least one class size.

The slab allocator module 206 may receive the memory slab status data from the memory allocator module 300 via one or more signals 426. The slab allocator module 206 may track use of the multiple pre-allocated memory slabs for the multiple class sizes based on the memory slab status data. In some aspects, the slab allocator module 206 may respond to the memory slab status data by pre-allocating at least one additional memory slab for at least one class size. The slab allocator module 206 may generate and send pointers for the pre-allocated at least one additional memory slab for at least one class size to the memory allocator module 300 via the one or more signals 420.

The direct memory access module 408 may be connected to the one or more output buffers 404 and the memory allocator module 300. The direct memory access module 408 may receive the memory write address and the compression information from the memory allocator module 300 via the one or more signals 424. Based on the one or more identifiers of the one or more output buffers 404 and/or the compressed data size, the direct memory access module 408 may retrieve the compressed data from the one or more output buffers 404 via one or more signals 430. Based on the memory write address, the direct memory access module 408 may write the compressed data to a memory (e.g., memory 16, 36, storage memory 24, memory 202 in FIGS. 1 and 2) via one or more signals 432.

In some aspects, the slab allocator module 206 may send a memory slab release signal to the memory allocator module 300 via the one or more signals 420. In some aspects, a client application or another component of the single pass memory footprint compression system 400, configured to modulate software/external control of memory allocator module 300, may send the memory slab release signal to the memory allocator module 300. The memory slab release signal may be configured to indicate to the memory allocator module 300 to release, or no longer use the pointers for, at least one memory slab for at least one class size. In some aspects, the memory allocator module 300 may receive the memory slab release signal from the slab allocator module 206 via the one or more signals 420. In some aspects, the memory allocator module 300 may receive the memory slab release signal from the client application or another component of the single pass memory footprint compression system 400. The memory allocator module 300 may respond to the memory slab release signal by removing or making unavailable the pointers for the at least one memory slab for at least one class size.

In some instances, the compressed data size may exceed the largest class size or capacity of the output buffers 404. The one or more compressors 402 writing the compressed data to the output buffers 404 may be configured to identify when a compressed data size exceeds the largest class size or capacity of the output buffers 404. For example, the one or more compressors 402 may identify that data for compression remains despite already compressed data having a size that exceeds the largest class size or the capacity of the output buffers 404. In response to identifying that the compressed data size exceeds the largest class size or capacity of the output buffers 404, the single pass memory footprint compression system 400 may transition from implementing single pass memory footprint compression to the known two pass approach to complete the compression operation. To implement the transition, the compressed data stored in the output buffers 404 and subsequent compressed data from the one or more compressors 402 may be written out to a memory (e.g., memory 16, 36, storage memory 24, memory 202 in FIGS. 1 and 2) for temporary storage, directly, via the output buffers 404, or another path.

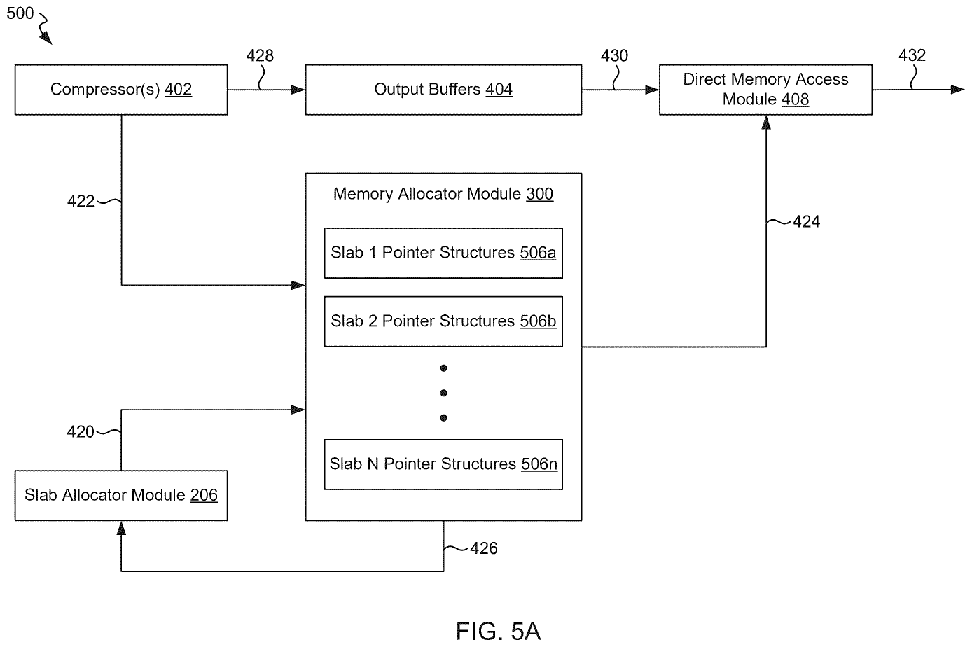

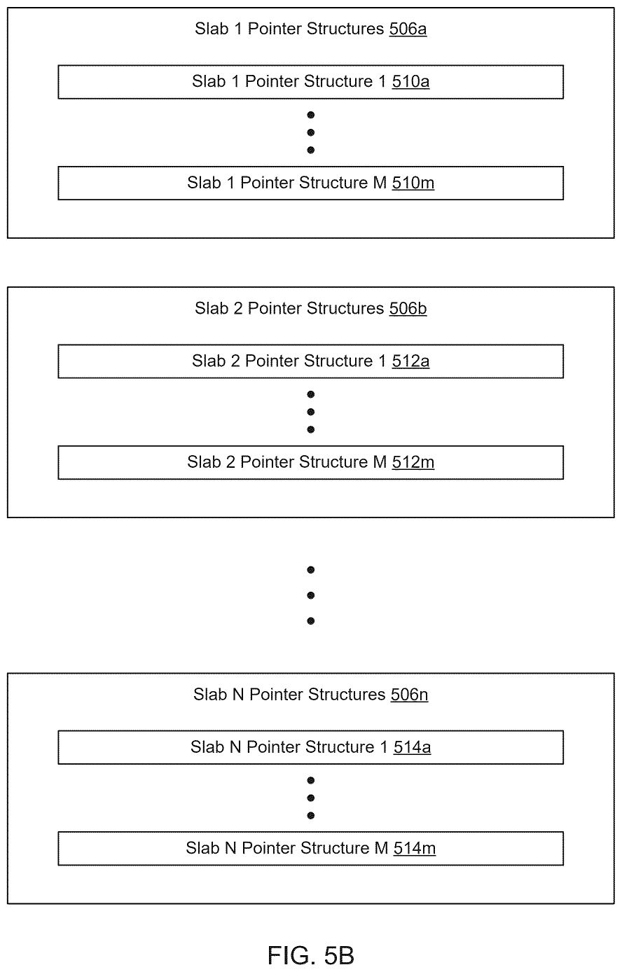

FIGS. 5A and 5B illustrate an example of a single pass memory footprint compression system 500 in the computing device (e.g., computing device 10 in FIG. 1) suitable for implementing various aspects. With reference to FIGS. 1 5B, the single pass memory footprint compression system 500 may include one or more compressors 402, one or more output buffers 404, the slab allocator module 206, the memory allocator module 300, and a direct memory access module 408. The components single pass memory footprint compression system 400 may be connected to and transmit signals between each other via one or more interconnects (e.g., interconnect 32 in FIG. 1). The components of the single pass memory footprint compression system 500 may be configured and function as described for like numbered components of the single pass memory footprint compression system 400 described with reference to FIG. 4. Descriptions of the components of the single pass memory footprint compression system 500 may be in addition to or alternative to the descriptions for like numbered components of the single pass memory footprint compression system 400.

The slab allocator module 206 may be connected to the memory allocator module 300. The slab allocator module 206 may pre-allocate multiple memory slabs for multiple class sizes and initially send pointers for at least one pre-allocated memory slab for multiple class sizes via one or more signals 420 to the memory allocator module 300. In some aspects, the slab allocator module 206 may subsequently send pointers for at least one pre-allocated memory slab for at least one class size via the one or more signals 420 to the memory allocator module 300.

The memory allocator module 300 may receive the pointers for the pre-allocated memory slabs for the class sizes from the slab allocator module 206 via the one or more signals 420 and store the pointers in groups of slab pointer structures 506a, 506b, 506n. The number, “N”, of groups of slab pointer structures 506a, 506b, 506n may correspond to the number of class sizes for the memory slabs. Each group of slab pointer structures 506a, 506b, 506n may include multiple slab pointer structures 510a, 510m, 512a, 512m, 514a, 514m. The number, “M”, of slab pointer structures 510a, 510m, 512a, 512m, 514a, 514m may be any integer two or greater. For example, each group of slab pointer structures 506a, 506b, 506n may be configured to store the pointers for multiple pre-allocated memory slabs for a class size. Each slab pointer structures 510a, 510m, 512a, 512m, 514a, 514m may be configured to store the pointers for a pre-allocated memory slab for a class size. The slab pointer structures 510a, 510m, 512a, 512m, 514a, 514m may be physical memory components, such as registers, buffers, etc., configured to store the pointers for the pre-allocated memory slabs for the class sizes in data structures, such as arrays, linked lists, etc. In some aspects, the slab pointer structures 510a, 510m, 512a, 512m, 514a, 514m may also be configured to store memory slab status, indexing information, etc.

The memory allocator module 300 may send memory slab status data to the slab allocator module 206 via one or more signals 426. The memory slab status data may be configured to indicate to the slab allocator module 206 which parts or how much of at least one memory slab for at least one class size are used or remain unused. In some aspects, the memory slab status data may be configured to indicate to the slab allocator module 206 when, how frequently, or when at least one memory slab for at least one class size is used. In some aspects, the memory slab status data may be configured to indicate to the slab allocator module 206 to generate and/or send pointers for at least one pre-allocated memory slab for at least one class size for which pointers have not yet been generated and/or sent.

The slab allocator module 206 may receive the memory slab status data from the memory allocator module 300 via one or more signals 426. The slab allocator module 206 may track use of the multiple pre-allocated memory slabs for the multiple class sizes based on the memory slab status data. In some aspects, the slab allocator module 206 may respond to the memory slab status data by generating and/or sending pointers for the at least one pre-allocated memory slab for at least one class size for which pointers have not yet been generated and/or sent to the memory allocator module 300 via the one or more signals 420.

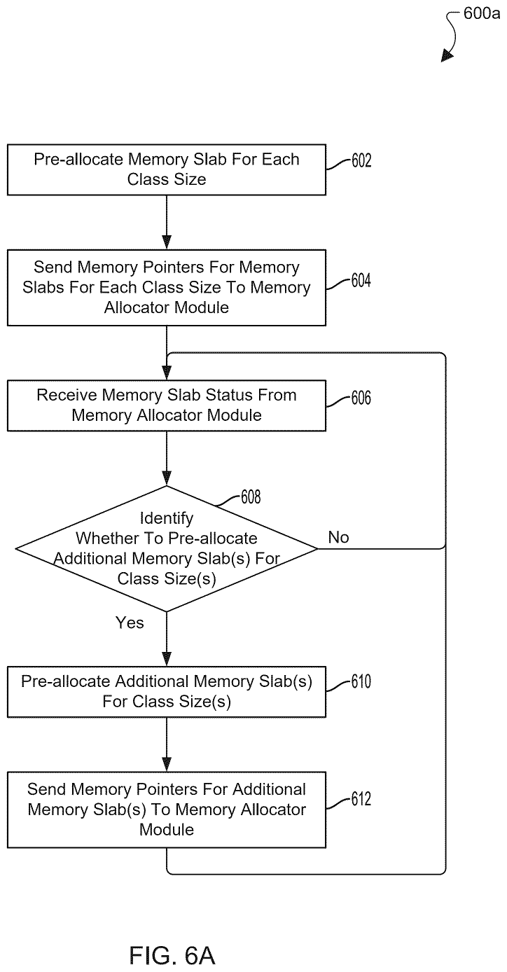

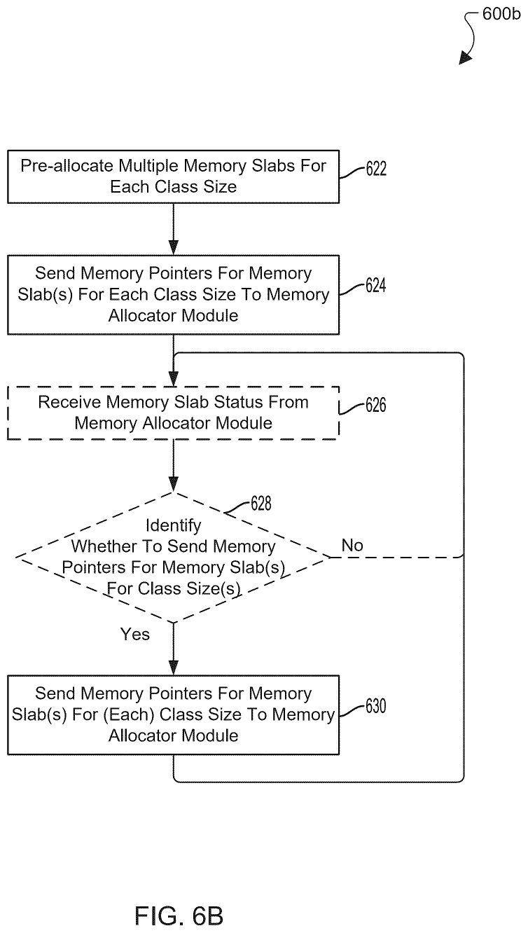

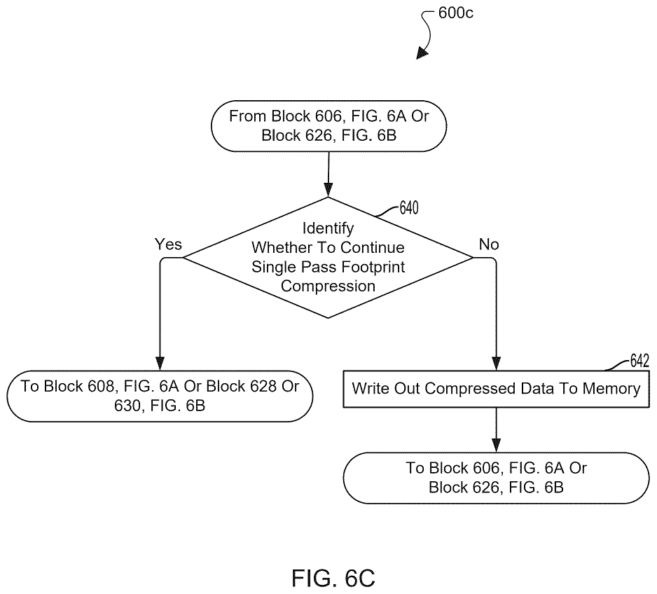

FIGS. 6A 6C illustrate example methods 600a, 600b for pre-allocating memory for single pass memory footprint compression according to one or more aspects. With reference to FIGS. 1-6C, the methods 600a, 600b, 600c may be implemented in a computing device (e.g., computing device 10, 200 in FIGS. 1 and 2), in hardware (e.g., slab allocator module 206, modules 208-211 in FIGS. 2, 4, and 5A), in software (e.g., slab allocator module 206, modules 208-211 in FIGS. 2, 4, and 5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the methods 600a, 600b, 600c is referred to herein as a “slab allocator device.”

With reference to the method 600a and FIG. 6A, in block 602, the slab allocator device may pre-allocate a memory slab for each class size. For which of the various class sizes the slab allocator device may pre-allocate the memory slabs may be statically preprogrammed or use case dependent and dynamically determined. The class sizes for which the slab allocator device may pre-allocate the memory slabs may be all or less than all of the class sizes. In some aspects, the slab allocator device pre-allocating the memory slab for each class size in block 602 may be a processing system (e.g., processing system 14, 204 in FIGS. 1 and 4), a slab allocator module (e.g., slab allocator module 206 in FIGS. 2, 4, and 5A), and/or a slab pointer allocator module (e.g., slab pointer allocator module 208 in FIG. 2).

In block 604, the slab allocator device may send memory pointers for the memory slabs for each class size to a memory allocator module (e.g., memory allocator module 300 in FIGS. 3-5A). The pointers may be pointers to locations in a memory (e.g., memory 16, 36, 202 in FIGS. 1 and 2) for the pre-allocated memory slabs. The slab allocator device may send the pointers to the memory allocator module for use in identifying memory write addresses for compressed data for implementing single pass memory footprint compression. In some aspects, the slab allocator device sending the memory pointers for the memory slabs for each class size to the memory allocator module in block 604 may be the processing system, the slab allocator module, and/or the slab pointer allocator module.

In block 606, the slab allocator device may receive a memory slab status from the memory allocator module. The memory slab status may include data configured to indicate to the slab allocator device which parts or how much of at least one memory slab for at least one class size are used or remain unused. The slab allocator device may track which parts or how much of at least one memory slab for at least one class size are used or remain unused. In some aspects, the slab allocator device receiving the memory slab status from the memory allocator module in block 606 may be the processing system, the slab allocator module, and/or a slab status tracker module (e.g., slab status tracker module 210 in FIG. 2).

In determination block 608, the slab allocator device may identify whether to pre-allocate at least one additional memory slab for at least one class size. Identifying whether to pre-allocate at least one additional memory slab for at least one class size may be based on a slab usage threshold. For example, the slab usage threshold may be of an amount of used or unused space of a memory slab for a class size. The slab usage threshold may be all or less than all of the space of the memory slab for the class size being used or none of more than none of the space being unused. As a further example, the slab usage threshold may be integration information, such as frequency of class size use or time since last use of the class size. The slab usage threshold may be a value representing an upper or lower threshold for frequency of class size use or time since last use of the class size. In some aspects the usage threshold can be a minimum usage frequency. In some aspects the usage threshold can be a calculation that a probability of a size class being used soon exceeds a minimum probability. This could be combined with the amount of space left on the current slab for that size class, and/or whether another slab has already been pre-allocated for that size class. An example, this option in pseudocode is provided below.
if (next slab not pre-allocated){
Prob=class size usage/time unit//or other estimator
Rem=remaining usable size classes in current slab
Time=Rem/Prob
If (Time<threshold) do prealocate that class size
}

It will be appreciated that the foregoing pseudo code facilitates pre-allocating another slab before the current slab is out of space. By converting the usage frequency to an estimated time remaining, the system can predict when to start allocating a new slab to try to prevent from running out of space.

In some aspects, the slab allocator device may be triggered to pre-allocate at least one additional memory slab for at least one class size based on a comparison of memory slab status data to the slab usage threshold. In some aspects, the slab allocator device identifying whether to pre-allocate at least one additional memory slab for at least one class size in determination block 608 may be the processing system, the slab allocator module, and/or the slab status tracker module.

In response to identifying to pre-allocate at least one additional memory slab for at least one class size (i.e., determination block 608=“Yes”), the slab allocator device may pre-allocate at least one additional memory slab for at least one class size in block 610. The slab allocator device may pre-allocate at least one additional memory slab for at least one class size similarly as described for pre-allocating the memory slab for each class size in block 602. In some aspects, the slab allocator device pre-allocating at least one additional memory slab for at least one class size in block 610 may be the processing system, the slab allocator module, and/or the slab pointer allocator module.

In block 612, the slab allocator device may send memory pointers for at least one additional memory slab for at least one class size. The slab allocator device may send the memory pointers for the at least one additional memory slab for at least one class size similarly as described for sending the memory pointers for the memory slabs for each class size to the memory allocator module in block 604. In some aspects, the slab allocator device sending the memory pointers for the at least one additional memory slab for at least one class size in block 612 may be the processing system, the slab allocator module, and/or the slab pointer allocator module.

In response to identifying not to pre-allocate at least one additional memory slab for at least one class size (i.e., determination block 608=“No”); or following sending the memory pointers for the at least one additional memory slab for at least one class size in block 612, the slab allocator device receiving the memory slab status from the memory allocator module in block 606. In some aspects, the slab allocator device receiving the memory slab status from the memory allocator module in block 606 may be the processing system, the slab allocator module, and/or the slab status tracker module.

With reference to the method 600b and FIG. 6B, in block 622, the slab allocator device may pre-allocate multiple memory slabs for each class size. For which of the various class sizes the slab allocator device may pre-allocate the memory slabs may be statically preprogrammed or use case dependent dynamically determined. The class sizes for which the slab allocator device may pre-allocate the memory slabs may be all or less than all of the class sizes. In some aspects, the slab allocator device pre-allocating the multiple memory slabs for each class size in block 622 may be a processing system (e.g., processing system 14, 204 in FIGS. 1 and 4), a slab allocator module (e.g., slab allocator module 206 in FIGS. 2, 4, and 5A), and/or a slab pointer allocator module (e.g., slab pointer allocator module 208 in FIG. 2).

In block 624, the slab allocator device may send memory pointers for at least one memory slab for each class size to a memory allocator module (e.g., memory allocator module 300 in FIGS. 3-5A). The pointers may be pointers to locations in a memory (e.g., memory 16, 36, 202 in FIGS. 1 and 2) for the pre-allocated memory slabs. The slab allocator device may send the pointers to the memory allocator module for use in identifying memory write addresses for compressed data for implementing single pass memory footprint compression. In some aspects, the slab allocator device sending the memory pointers for the at least one memory slab for each class size to the memory allocator module in block 624 may be the processing system, the slab allocator module, and/or the slab pointer allocator module.

In optional block 626, the slab allocator device may receive a memory slab status from the memory allocator module. The memory slab status may include data configured to indicate to the slab allocator device which parts or how much of at least one memory slab for at least one class size are used or remain unused. The slab allocator device may track which parts or how much of at least one memory slab for at least one class size are used or remain unused. In some aspects, the slab allocator device receiving the memory slab status from the memory allocator module in optional block 626 may be the processing system, the slab allocator module, and/or a slab status tracker module (e.g., slab status tracker module 210 in FIG. 2).

In optional determination block 628, the slab allocator device may identify whether to send pointers for at least one additional memory slab for at least one class size. In some aspects, sending pointers for the at least one additional memory slab for at least one class size may include generating pointers for the at least one additional memory slab for at least one class size. In some aspects, the at least one additional memory slab for at least one class size may be at least one pre-allocated memory slab for at least one class size for which pointers have not yet been generated and/or sent. Identifying whether to generate and/or send pointers for the at least one memory slab for at least one class size for which pointers have not yet been generated and/or sent may be based on the slab usage threshold. In some aspects, the slab allocator module may be triggered to generate and/or send pointers for the at least one pre-allocated memory slab for at least one class size for which pointers have not yet been generated and/or sent based on a comparison of memory slab status data to the slab usage threshold. In some aspects, the slab allocator device identifying whether to send the pointers for the at least one additional memory slab for at least one class size in optional determination block 628 may be the processing system, the slab allocator module, and/or the slab status tracker module.

Following sending the memory pointers for the at least one memory slab for each class size to the memory allocator module in block 624; or in response to identifying to send the pointers for the at least one additional memory slab for at least one class size (i.e., optional determination block 628=“Yes”), the slab allocator device may send the memory pointers for the at least one additional memory slab for at least one class size in block 630. The slab allocator device may send the memory pointers for the at least one additional memory slab for at least one class size similarly as described for sending the memory pointers for the at least one memory slab for each class size to the memory allocator module in block 624. In some aspects, the slab allocator device may continually, periodically, or episodically send memory pointers for at least one additional memory slab for at least one class size in block 630. In some aspects, the slab allocator device sending the memory pointers for the at least one additional memory slab for at least one class size in block 630 may be the processing system, the slab allocator module, and/or the slab pointer allocator module.

In some aspects, in response to identifying not to send the pointers for the at least one additional memory slab for at least one class size (i.e., optional determination block 628=“No”); or following sending the memory pointers for the at least one additional memory slab for at least one class size in block 630, the slab allocator device may receive a memory slab status from the memory allocator module in optional block 626. In some aspects, the slab allocator device receiving the memory slab status from the memory allocator module in optional block 626 may be the processing system, the slab allocator module, and/or the slab status tracker module.

In some aspects, the method 600c, described with reference to FIG. 6C, may be implemented as part of or in parallel with the methods 600a, 600b. Following receiving the memory slab status from the memory allocator module in block 606; or following receiving the memory slab status from the memory allocator module in optional block 626, the slab allocator device may determine whether to continue single pass memory footprint compression in determination block 640. In some aspects, the slab allocator device determining whether to continue single pass memory footprint compression may be a processing system (e.g., processing system 14, 204 in FIGS. 1 and 4), a slab allocator module (e.g., slab allocator module 206 in FIGS. 2, 4, and 5A), and/or a slab status tracker module (e.g., slab status tracker module 210 in FIG. 2). The memory slab status may be configured to indicate to the slab allocator device whether to continue or not continue single pass memory footprint compression. The slab allocator device may interpret the memory slab status to determine whether to continue single pass memory footprint compression.

In some aspects, a determination whether to continue single pass memory footprint compression may be based on available storage for single pass memory footprint compression. For example, the slab allocator device may determine to not continue single pass memory footprint compression in response to the memory slab status indicating to the slab allocator device that no pre-allocated memory slab for the class size has sufficient space to store the compressed data. In some aspects, a determination whether to continue single pass memory footprint compression may be based on time to access to write to a pre-allocated memory slab for the class size. For example, the slab allocator device may determine to not continue single pass memory footprint compression in response to the memory slab status indicating to the slab allocator device that time to access and write to a pre-allocated memory slab for the class size may exceeds the time threshold.

In response to determining to continue single pass memory footprint compression (i.e., determination block 640=“Yes”), the slab allocator device may identify whether to pre-allocate at least one additional memory slab for at least one class size in determination block 608 of the method 600a; identify whether to send the pointers for the at least one additional memory slab for at least one class size in optional determination block 628 of the method 600b; or send the memory pointers for the at least one additional memory slab for at least one class size in block 630 of the method 600b. In some aspects, the slab allocator device determining whether to pre-allocate at least one additional memory slab for at least one class size may be the processing system, the slab allocator module, and/or the slab status tracker module. In some aspects, the slab allocator device determining whether to send the pointers for the at least one additional memory slab for at least one class size may be the processing system, the slab allocator module, and/or the slab status tracker module. In some aspects, the slab allocator device sending the memory pointers for the at least one additional memory slab for at least one class size in block 630 may be the processing system, the slab allocator module, and/or a slab pointer allocator module (e.g., slab pointer allocator module 208 in FIG. 2).

In response to determining to not continue single pass memory footprint compression (i.e., determination block 640=“No”), the slab allocator device may write out compressed data to a memory (e.g., memory 16, 36, storage memory 24, memory 202 in FIGS. 1 and 2) for temporary storage in block 642. The slab allocator device may generate and send a compressed data write out signal to one or more compressors (e.g., compressors 402 in FIGS. 4 and 5A). The compressed data write out signal may be configured to trigger the one or more compressors to write out the compressed data stored in one or more output buffers (e.g., output buffer 404 in FIGS. 4 and 5A). The one or more compressors may write out subsequent compressed data compressed by the one or more compressors to the memory. This write out may be directly via the one or more output buffers or another path. The memory may store the compressed data for implementation of the known two pass approach to complete the compression operation. In some aspects, the slab allocator device writing out the compressed data to the memory for temporary storage in block 642 may be the processing system, the slab allocator module, and/or the slab status tracker module.

After writing out the compressed data to the memory for temporary storage in block 642, the slab allocator device may determine whether to pre-allocate at least one additional memory slab for at least one class size in determination block 608 of the method 600a; or receive the memory slab status from the memory allocator module in optional block 626 of the method 600b. In some aspects, the slab allocator device identifying whether to pre-allocate at least one additional memory slab for at least one class size may be the processing system, the slab allocator module, and/or the slab status tracker module. In some aspects, the slab allocator device receiving the memory slab status from the memory allocator module in optional block 626 may be the processing system, the slab allocator module, and/or the slab status tracker module.

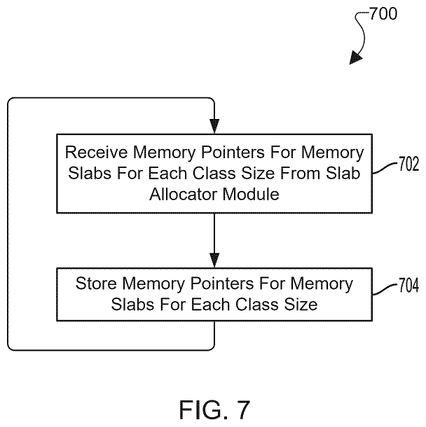

FIG. 7 illustrates an example method 700 for pre-allocating memory for single pass memory footprint compression according to one or more aspects. With reference to FIGS. 1-7, the method 700 may be implemented in a computing device (e.g., computing device 10, 200 in FIGS. 1 and 2), in hardware (e.g., memory allocator module 300, modules 302-306 in FIGS. 3-5A), in software (e.g., memory allocator module 300, modules 302-306 in FIGS. 3-5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 700 is referred to herein as a “memory allocator device.”

In block 702, the memory allocator device may receive memory pointers for at least one memory slab for each class size from a slab allocator module (e.g., slab allocator module 206 in FIGS. 2, 4, and 5A). The memory pointers may be for pre-allocated memory slabs for multiple class sizes. In some aspects, the memory allocator device receiving the memory pointers for the at least one memory slab for each class size from the slab allocator module in block 702 may be a processing system (e.g., processing system 14, 204 in FIGS. 1 and 4), a memory allocator module (e.g., memory allocator module 300 in FIGS. 3-5A), and/or a slab pointer module (e.g., slab pointer module 302 in FIG. 3).

In block 704, the memory allocator device may store the memory pointers for the at least one memory slab for each class size. For example, the memory allocator device may store the pointers for memory slabs for multiple class sizes in registers or buffers associated with the memory slabs for multiple class sizes. As another example, the memory allocator device may store the pointers for memory slabs for multiple class sizes as slab pointer data structures (e.g., slab pointer structure 406a-406n, 506a-506n, 510a-510m, 512a-512m, 514a-514m in FIGS. 4-5B), such as arrays, link lists, etc. In examples where a single memory slab is initially pre-allocated for each of the multiple class sizes, a single slab pointer data structure for each of the multiple class sizes may be used to store pointers for a corresponding memory slab for a class size. In examples where multiple memory slabs are initially pre-allocated for each of the multiple class sizes, multiple slab pointer data structures for each of the multiple class sizes may be used to store pointers for corresponding memory slabs of a class size. In some aspects, the memory allocator device storing the memory pointers for the at least one memory slab for each class size in block 704 may be the processing system, the memory allocator module, and/or the slab pointer module.

In some aspects, the memory allocator device may continually, periodically, or episodically receive memory pointers for at least one memory slab for each class size from a slab allocator module in block 702. In some aspects, the memory allocator device receiving the memory pointers for the at least one memory slab for each class size from the slab allocator module in block 702 may be the processing system, the memory allocator module, and/or the slab pointer module.

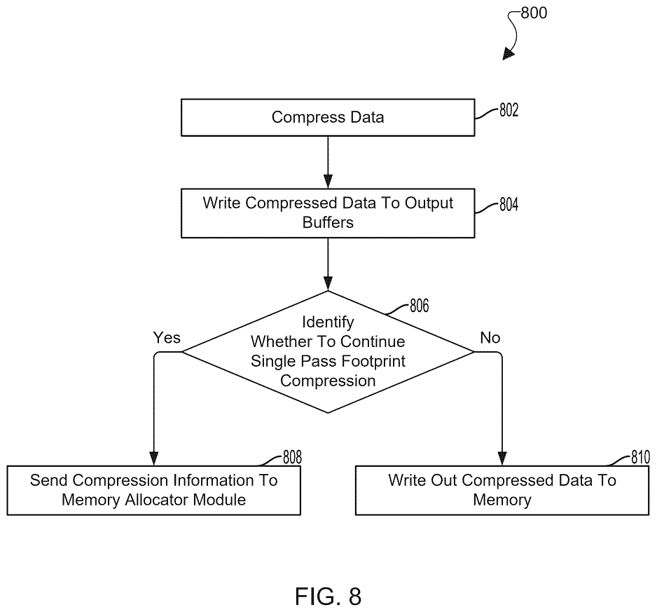

FIG. 8 illustrates an example method 800 for single pass memory footprint compression according to one or more aspects. With reference to FIGS. 1-8, the method 800 may be implemented in a computing device (e.g., computing device 10, 200 in FIGS. 1 and 2), in hardware (e.g., compressor 402 in FIGS. 4 and 5A), in software (e.g., compressor 402 in FIGS. 4 and 5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 700 is referred to herein as a “compressor device.”

In block 802, the compressor device may compress data. The compressor device may use any compression scheme for any data compatible with ZRAM. For example, compression schemes may include common compression algorithms, e.g., LZ4, LZ0, or any similar compression algorithms, including proprietary compression algorithms. Compressing the data may generate compressed data and compression information for the compressed data, such as a compressed data size. In some aspects, the compressor device compressing the data in block 802 may be a processing system (e.g., processing system 14, 204 in FIGS. 1 and 4) and/or a compressor (e.g., compressor 402 in FIGS. 4 and 5A).

In block 804, the compressor device may write the compressed data to one or more output buffers (e.g., output buffer 404 in FIGS. 4 and 5A). In some aspects the compressor device may sequentially write the compressed data to one or more output buffers. Writing the compressed data to the one or more output buffers may generate compression information for the compressed data, such as one or more identifiers of the one or more output buffers to which the compressed data is written. In some aspects, the compressor device writing the compressed data to the one or more output buffers in block 804 may be the processing system and/or the compressor.

In determination block 806, the compressor device may determine whether to continue single pass memory footprint compression. In some aspects, the compressor device determining whether to continue single pass memory footprint compression may be the processing system and/or the compressor. A determination whether to continue single pass memory footprint compression may be based on available storage for single pass memory footprint compression. In some aspects, the compressor device may determine to continue single pass memory footprint compression for a compressed data size that is less than or equal to a capacity of the one or more output buffers. The compressor device may determine not to continue single pass memory footprint compression for a compressed data size that is greater than the capacity of the one or more output buffers. In some aspects, the compressor device may determine to continue single pass memory footprint compression for a compressed data size that is less than or equal to a largest class size for a memory slab. The compressor device may determine to not continue single pass memory footprint compression for a compressed data size that is greater than the largest class size for a memory slab.

For example, the compressor device may determine whether to continue single pass memory footprint compression based on the compressed data size of the already compressed data as compared to a compressed data size threshold, and/or whether data remains to be compressed. The compressed data size threshold may represent a limit of an amount of compressed data that may be stored in a memory slab for a class size, such as a largest class size, or the one or more output buffers, such as based on the capacity of the one or more output buffers. In instances in which the compressed data size is less than the compressed data size threshold, the compressor device may continue single pass memory footprint compression. In instances in which the compressed data size is equal to the compressed data size threshold and data remains to be compressed, the compressor device may continue single pass memory footprint compression. In instances in which the compressed data size is greater than the compressed data size threshold, the compressor device may not continue single pass memory footprint compression.

In response to determining to continue single pass memory footprint compression (i.e., determination block 806=“Yes”), the compressor device may send the compression information to a memory allocator module (e.g., memory allocator module 300 in FIGS. 3-5A) in block 808. In some aspects, the compression information sent to the memory allocator module may include the compressed data size and the one or more identifiers of the one or more output buffers to which the compressed data is written. In some aspects, the compressor device sending the compression information to the memory allocator module in block 808 may be the processing system and/or the compressor.

In response to determining to not continue single pass memory footprint compression (i.e., determination block 806=“No”), the compressor device may write out compressed data to a memory (e.g., memory 16, 36, storage memory 24, memory 202 in FIGS. 1 and 2) for temporary storage in block 810. The compressor device may write out the compressed data stored in the one or more output buffers and subsequent compressed data compressed by the compressor device, directly, via the output buffers, or another path, to the memory. The memory may store the compressed data for implementation of the two pass approach to complete the compression operation. In some aspects, the compressor device writing out the compressed data to the memory for temporary storage in block 810 may be the processing system and/or the compressor.

In some aspects, operations in any of the blocks 802-810 may be executed in parallel with any of the other blocks 802-810. For example, operations in block 802 and optionally block 804 may be executed in parallel with execution of block 810 so that data that is compressed subsequent to identifying to not continue single pass memory footprint compression may be written out to the memory for temporary storage.

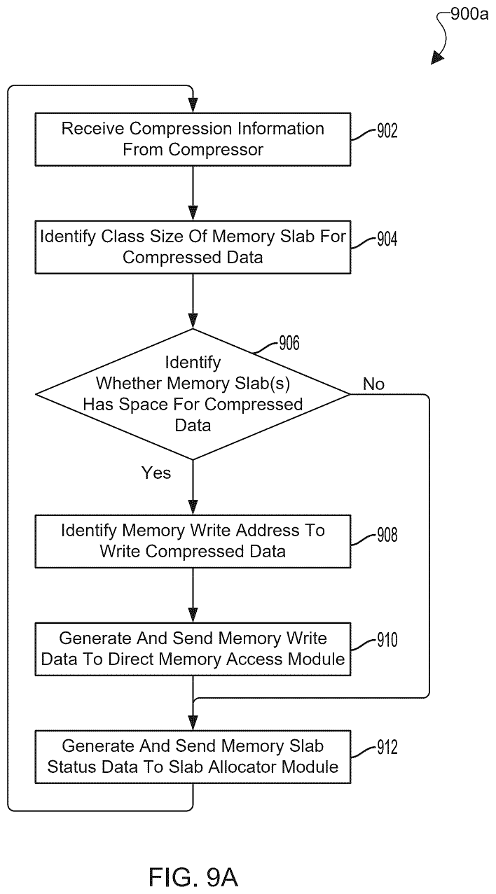

FIGS. 9A and 9B illustrates example methods 900a, 900b for single pass memory footprint compression according to one or more aspects. With reference to FIGS. 1-9B, the methods 900a, 900b may be implemented in a computing device (e.g., computing device 10, 200 in FIGS. 1 and 2), in hardware (e.g., memory allocator module 300, modules 302-306 in FIGS. 3-5A), in software (e.g., memory allocator module 300, modules 302-306 in FIGS. 3-5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the methods 900a, 900b is referred to herein as a “memory allocator device.”

Referring to the method 900a and FIG. 9A, in block 902, the memory allocator device may receive compression information from a compressor (e.g., compressor 402 in FIGS. 4 and 5A). In some aspects, the compression information may include a compressed data size for compressed data written to one or more output buffers (e.g., output buffer 404 in FIGS. 4 and 5A) and one or more identifiers of the one or more output buffers to which the compressed data is written. In some aspects, the memory allocator device receiving the compression information from the compressor in block 902 may be a processing system (e.g., processing system 14, 204 in FIGS. 1 and 4), a memory allocator module (e.g., memory allocator module 300 in FIGS. 3-5A), and/or a memory address module (e.g., memory address module 304 in FIG. 3).

In block 904, the memory allocator device may identify a class size for a memory slab in which the compression data may be stored. Based on the compressed data size, the memory allocator device may identify a class size that is larger than the compression data size. In examples in which there may be multiple class sizes larger than the compression data size, the memory allocator device may select a smallest class size of the multiple class sizes larger than the compression data size. In other examples, the memory allocator device may select a smallest class size based on availability of a memory slab for the class size based on efficiency over memory savings. In some aspects, the memory allocator device identifying the class size for the memory slab in which the compression data may be stored in block 904 may be the processing system, the memory allocator module, and/or the memory address module.

In determination block 906, the memory allocator device may identify whether at least one memory slab has space for storing the compressed data. The memory allocator device may identify whether a pre-allocated memory slab for the class size large enough to store the compressed data has sufficient unused space to store the data. An amount of unused space of a pre-allocated memory slab for the class size may be identified based on slab status data generated by the memory allocator device described further herein. A pre-allocated memory slab for the class size having sufficient space to store the data may be selected for storing the compressed data. In some aspects, the memory allocator device identifying whether at least one memory slab has space for storing the compressed data in determination block 906 may be the processing system, the memory allocator module, and/or the memory address module.

In response to determining that at least one memory slab has space for storing the compressed data (i.e., determination block 906=“Yes”), the memory allocator device may identify a memory write address of a memory (e.g., memory 16, 36, 202 in FIGS. 1 and 2) to write the compressed data in block 908. The memory allocator device may retrieve a pointer for the memory slab for the class size and use the pointer and compressed data size to identify the memory write address for writing the compressed data to the memory slab for the class size. The memory write address may be calculated based on the memory slab address plus the offset within the memory slab. The offset may be based on the free space calculation to determine the offset of the free space of the memory slab. In some aspects, the memory allocator device identifying the memory write address of the memory to write the compressed data in block 908 may be the processing system, the memory allocator module, and/or the memory address module.

In block 910, the memory allocator device may generate and send write memory data to a direct memory access module (e.g., direct memory access module 408 in FIGS. 4 and 5A). The write memory data may include the memory write address and compression information, such as the one or more identifiers of the one or more output buffers on which the compressed data is stored and/or the compressed data size. In some aspects, the memory allocator device generating and sending the write memory data to the direct memory access module in block 910 may be the processing system, the memory allocator module, and/or the memory address module.

In response to determining that not at least one memory slab has space for storing the compressed data (i.e., determination block 906=“No”); or following generating and sending the write memory data to the direct memory access module in block 910, the memory allocator device may generate and send slab status data to the slab allocator module in block 912. The memory allocator device may be configured to track usage of the memory slabs for multiple class sizes. Based on the use of the pointers and/or the identified memory write addresses and the compressed data sizes, the memory allocator device may identify which parts or how much of the memory slabs for multiple class sizes are used or remain unused. In some aspects, memory slab status data may be configured to indicate to the slab allocator module which parts or how much of the memory slabs for multiple class sizes are used or remain unused. In aspects in which no pre-allocated memory slab for the class size has sufficient space to store the compressed data, the memory slab status data may be configured to indicate to the slab allocator module to pre-allocate at least one additional memory slab for the class size. In aspects in which no pre-allocated memory slab for the class size has sufficient space to store the compressed data, the memory slab status data may be configured to indicate to the slab allocator module to generate and/or send pointers for at least one additional memory slab for the class size. In instances in which no pre-allocated memory slab for the class size has sufficient space to store the compressed data, the memory slab status data may be configured to indicate to the slab allocator module that it should transition from single pass memory footprint compression to the known two pass approach to complete the compression operation. In instances in which the time to access and write to a pre-allocated memory slab for the class size may exceed a time threshold, the memory slab status data may indicate to the slab allocator module that it should transition from single pass memory footprint compression to the two pass approach to complete the compression operation. In some aspects, the memory allocator device generating and sending the slab status data to the slab allocator module in block 912 may be the processing system, the memory allocator module, and/or a slab status module (e.g., slab status module 306 in FIG. 3).

Referring to the method 900b and FIG. 9B, determination blocks 920-926 may further describe determination block 906 of the method 900a described with reference to FIG. 9A.

In determination block 920, the memory allocator device may identify whether a memory slab for the class size in which the compressed data may be stored is pre-allocated. The memory allocator device may identify whether pointers for a memory slab for the class size are stored in a slab pointer data structure (e.g., slab pointer structure 406a-406n, 506a-506n, 510a-510m, 512a-512m, 514a-514m in FIGS. 4-5B). In some aspects, the memory allocator device identifying whether a memory slab for the class size in which the compressed data may be stored is pre-allocated in determination block 920 may be a processing system (e.g., processing system 14, 204 in FIGS. 1 and 4), a memory allocator module (e.g., memory allocator module 300 in FIGS. 3-5A), and/or a memory address module (e.g., memory address module 304 in FIG. 3).

In response to identifying that a memory slab for the class size in which the compressed data may be stored is pre-allocated (i.e., determination block 920=“Yes”), the memory allocator device may identify whether there is an unused memory pointer for the memory slab for the class size in determination block 922. The memory allocator device may locate an unused memory pointer for the memory slab for the class size in the slab pointer data structure for the memory slab for the class size. In some aspects, the memory allocator device identifying whether there is an unused memory pointer for the memory slab for the class size in determination block 922 may be the processing system, the memory allocator module, and/or the memory address module.

In response to identifying that there is not an unused memory pointer for the memory slab for the class size (i.e., determination block 922=“No”), the memory allocator device may identify whether another memory slab for the class size in which the compressed data may be stored is pre-allocated in optional determination block 924. The memory allocator device may implement optional determination block 924 similarly as described for determination block 920. In some aspects, the memory allocator device identifying whether another memory slab for the class size in which the compressed data may be stored is pre-allocated in optional determination block 924 may be the processing system, the memory allocator module, and/or the memory address module.

In response to identifying another memory slab for the class size in which the compressed data may be stored is pre-allocated (i.e., optional determination block 924=“Yes”), the memory allocator device may identify whether there is an unused memory pointer for the other memory slab for the class size in optional determination block 926. The memory allocator device may implement optional determination block 926 similarly as described for determination block 922. In some aspects, the memory allocator device identifying whether there is an unused memory pointer for the other memory slab for the class size in optional determination block 926 may be the processing system, the memory allocator module, and/or the memory address module.

In response to identifying that there is an unused memory pointer for the memory slab for the class size (i.e., determination block 922=“Yes”); or in response to identifying that there is an unused memory pointer for the other memory slab for the class size (i.e., determination block 926=“Yes”), the memory allocator device may identify a memory write address of a memory (e.g., memory 16, 36, 202 in FIGS. 1 and 2) to write the compressed data in block 908. In some aspects, the memory allocator device identifying the memory write address of the memory to write the compressed data in block 908 may be the processing system, the memory allocator module, and/or the memory address module.

In response to identifying that no memory slab for the class size in which the compressed data may be stored is pre-allocated (i.e., determination block 920=“No”); in response to identifying that there is not an unused memory pointer for the memory slab for the class size (i.e., determination block 922=“No”); or in response to identifying no other memory slab for the class size in which the compressed data may be stored is pre-allocated (i.e., optional determination block 924=“No”), the memory allocator device may generate and send slab status data to a slab allocator module (e.g., slab allocator module 206 in FIGS. 2, 4, and 5A) in block 912. In some aspects, the memory allocator device generating and sending the slab status data to the slab allocator module in block 912 may be the processing system, the memory allocator module, and/or a slab status module (e.g., slab status module 306 in FIG. 3).

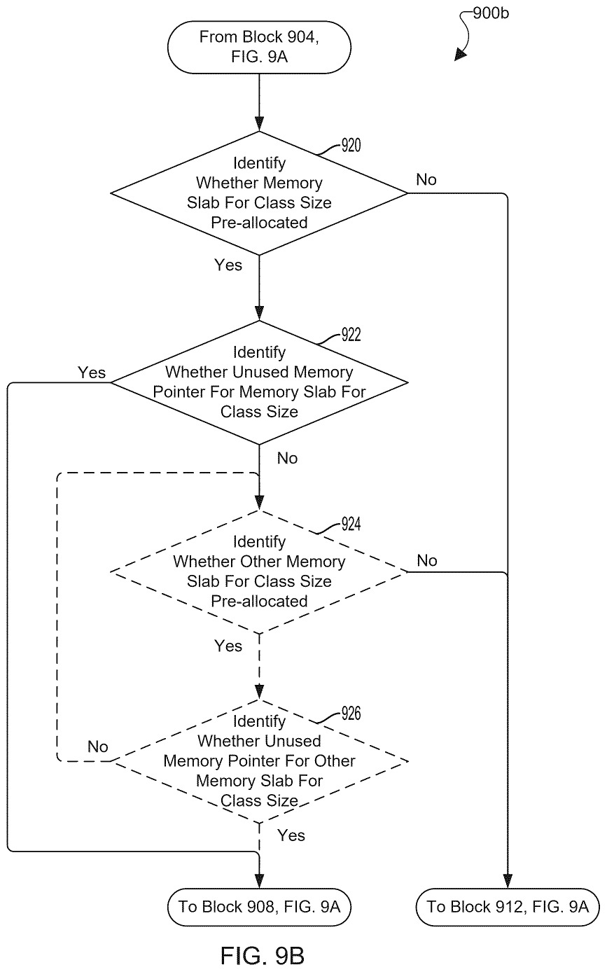

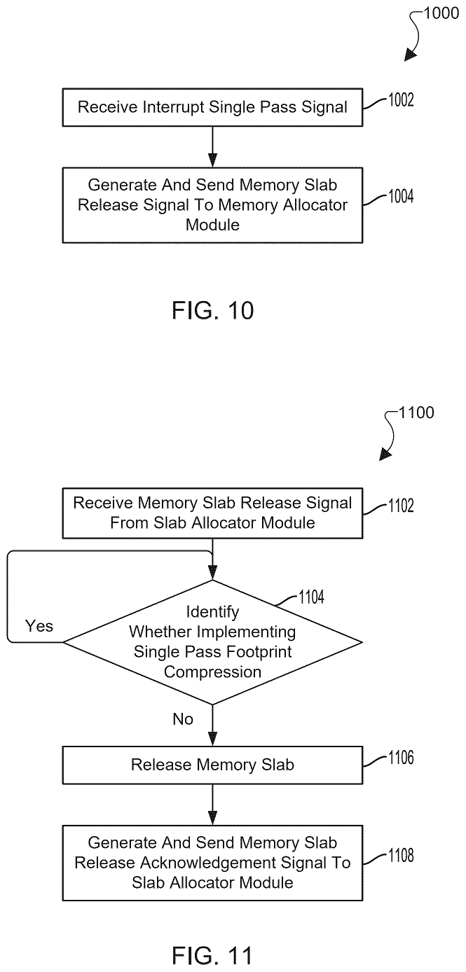

FIG. 10 illustrate an example method 1000 for single pass memory footprint compression according to one or more aspects. With reference to FIGS. 1-10, the method 1000 may be implemented in a computing device (e.g., computing device 10, 200 in FIGS. 1 and 2), in hardware (e.g., slab allocator module 206, modules 208-211 in FIGS. 2, 4, and 5A), in software (e.g., slab allocator module 206, modules 208-211 in FIGS. 2, 4, and 5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 1000 is referred to herein as a “slab allocator device.”

In block 1002, the slab allocator device may receive an interrupt single pass signal. In some aspects, the slab allocator device may receive the interrupt single pass signal from a client application wanting to access compressed data stored in a memory (e.g., memory 16, 36, 202 in FIGS. 1 and 2) in at least one memory slab for at least one class size. In some aspects, the slab allocator device may receive the interrupt single pass signal from a component of the slab allocator device, based on identification that at least one memory slab for at least one class size is full. In some aspects, the slab allocator device receiving the interrupt single pass signal in block 1002 may be a processing system (e.g., processing system 14, 204 in FIGS. 1 and 4), a slab allocator module (e.g., slab allocator module 206 in FIGS. 2, 4, and 5A), and/or a slab release module (e.g., slab release module 212 in FIG. 2).

In block 1004, the slab allocator device may generate and send a memory slab release signal to memory allocator module (e.g., memory allocator module 300 in FIGS. 3-5A). The slab allocator device may generate and send the memory slab release signal in response to receiving the interrupt single pass signal. The memory slab release signal may be configured to indicate to the memory allocator module to release, or no longer use the pointers for, at least one memory slab for at least one class size. In some aspects, the slab allocator device generating and sending the memory slab release signal to the memory allocator module in block 1004 may be the processing system, the slab allocator module, and/or the slab release module.

FIG. 11 illustrates an example method 1100 for single pass memory footprint compression according to one or more aspects. With reference to FIGS. 1-11, the method 1100 may be implemented in a computing device (e.g., computing device 10, 200 in FIGS. 1 and 2), in hardware (e.g., memory allocator module 300, modules 302-306 in FIGS. 3-5A), in software (e.g., memory allocator module 300, modules 302-306 in FIGS. 3-5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 1100 is referred to herein as a “memory allocator device.”

In block 1102, the memory allocator device may receive a memory slab release signal from a slab allocator module (e.g., slab allocator module 206 in FIGS. 2, 4, and 5A). The memory slab release signal may be configured to indicate to the memory allocator module to release, or no longer use the pointers for, at least one memory slab for at least one class size. In some aspects, the memory allocator device receiving the memory slab release signal from the slab allocator module in block 1102 may be a processing system (e.g., processing system 14, 204 in FIGS. 1 and 4), a memory allocator module (e.g., memory allocator module 300 in FIGS. 3-5A), and/or a slab pointer module (e.g., slab pointer module 302 in FIG. 3).

In determination block 1104, the memory allocator device may identify whether the memory allocator device is actively implementing single pass memory footprint compression. In some aspects, the memory allocator device actively implementing single pass memory footprint compression may include the memory allocator device implementing any of blocks 902-912 and 920-926 described herein for the methods 900a, 900b with reference to FIGS. 9A and 9B. In some aspects, the memory allocator device identifying whether the memory allocator device is implementing single pass memory footprint compression in determination block 1104, may be the processing system, the memory allocator module, a memory address module (e.g., memory address module 304 in FIG. 3), and/or a slab status module (e.g., slab status module 306 in FIG. 3).

In response to determining that the memory allocator device is implementing single pass memory footprint compression (i.e., determination block 1104=“Yes”), the memory allocator device may repeat identifying whether the memory allocator device is implementing single pass memory footprint compression in determination block 1104. In some aspects, the memory allocator device identifying whether the memory allocator device is implementing single pass memory footprint compression in determination block 1104, may be the processing system, the memory allocator module, the memory address module, and/or the slab status module.

In response to determining that the memory allocator device is not implementing single pass memory footprint compression (i.e., determination block 1104=“No”), the memory allocator device may release the at least one memory slab for at least one class size in block 1106. The memory allocator device may respond to the memory slab release signal by removing or making unavailable the pointers for the at least one memory slab for at least one class size. In some aspects, the memory allocator device releasing the at least one memory slab for at least one class size in block 1106 may be the processing system, the memory allocator module, and/or the slab pointer module.

In block 1108, the memory allocator device may generate and send memory slab release acknowledgement signal to the slab allocator module. The memory slab release acknowledgement signal may be configured to indicate to the slab allocator module that the at least one memory slab for at least one class size has been released by the memory allocator device. In some aspects, the memory allocator device generating and sending the memory slab release acknowledgement signal to the slab allocator module in block 1108 may be the processing system, the memory allocator module, and/or the slab status module.

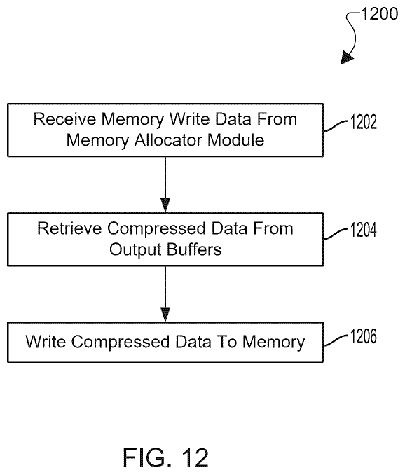

FIG. 12 illustrates an example method 1200 for single pass memory footprint compression according to one or more aspects. With reference to FIGS. 1-12, the method 1200 may be implemented in a computing device (e.g., computing device 10, 200 in FIGS. 1 and 2), in hardware (e.g., direct memory access module 408 in FIGS. 4 and 5A), in software (e.g., direct memory access module 408 in FIGS. 4 and 5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 1200 is referred to herein as a direct memory access device.

In block 1202, the direct memory access device may receive memory write data from a memory allocator module (e.g., memory allocator module 300 in FIGS. 3-5A). The memory write data may include a memory write address in a memory (e.g., memory 16, 36, 202 in FIGS. 1 and 2) at which to write compressed data from one or more output buffers (e.g., output buffer 404 in FIGS. 4 and 5A). The memory write data may include one or more identifiers of the one or more output buffers in which the compressed data is stored. In some aspects, the direct memory access device receiving the memory write data from the memory allocator module in block 1202 may be a processing system (e.g., processing system 14, 204 in FIGS. 1 and 4) and/or a direct memory access module (e.g., direct memory access module 408 in FIGS. 4 and 5A).

In block 1204, the direct memory access device may retrieve the compressed data from the one or more output buffers. Based on the one or more identifiers of the one or more output buffers storing the compressed data, the direct memory access device may access the one or more identified output buffers to retrieve the compressed data. In some aspects, based the one or more identifiers of the one or more output buffers storing the compressed data and a compressed data size, the direct memory access device may access the one or more identified output buffers to retrieve the compressed data. In some aspects, the direct memory access device retrieving the compressed data from the one or more output buffers in block 1204 may be the processing system and/or the direct memory access module.

In block 1206, the direct memory access device may write the compressed data to a memory (e.g., memory 16, 36, 202 in FIGS. 1 and 2). The compressed data may be written to the memory starting at the memory write address. In some aspects, the direct memory access device writing the compressed data to the memory in block 1206 may be the processing system and/or the direct memory access module.

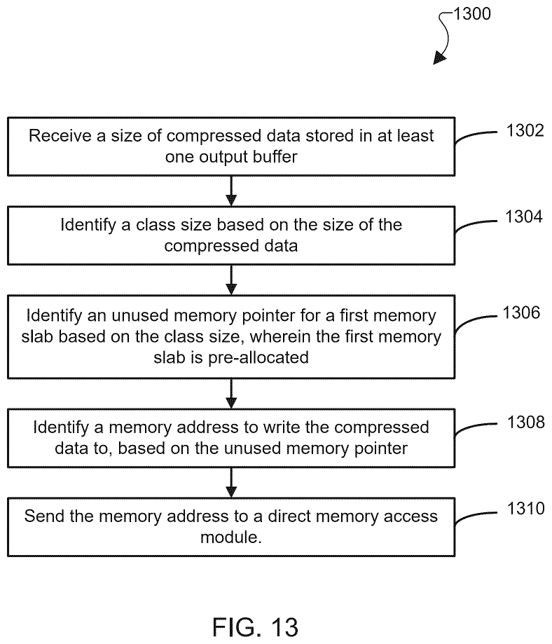

FIG. 13 illustrates an example method 1300 for single pass memory footprint compression according to one or more aspects. With reference to FIGS. 1-12, the method 1300 may be implemented in a computing device (e.g., computing device 10, 200 in FIGS. 1 and 2), in hardware (e.g., direct memory access module 408 in FIGS. 4 and 5A), in software (e.g., direct memory access module 408 in FIGS. 4 and 5A) executing in a processing system (e.g., processing system 14, 204 in FIGS. 1 and 2), or in a combination of a software-configured processor and dedicated hardware, that includes other individual components, such as various memories/caches (e.g., memory 16, 36, 202 in FIGS. 1 and 2). In order to encompass the alternative configurations enabled in various aspects, the hardware implementing the method 1300 is referred to herein as a “computing device”, which includes the various components and modules described herein.

The example method 1300 is associated with a method performed by a memory footprint compression system of a computing device for writing compressed data to memory, according to aspects of the disclosure. In some implementations, one or more process blocks of FIG. 13 may be performed by computing device (e.g., 202 including memory(s) 202 and processor(s)/processing system 204 and various related components and modules, which may generally be referred to herein as the memory footprint compression system).

As shown in FIG. 13, method 1300 may include, at block 1302, receiving a size of compressed data stored in at least one output buffer.

As further shown in FIG. 13, method 1300 may include, at block 1304, identifying a class size based on the size of the compressed data.

As further shown in FIG. 13, method 1300 may include, at block 1306, identifying an unused memory pointer for a first memory slab based on the class size, wherein the first memory slab is pre-allocated.

As further shown in FIG. 13, method 1300 may include, at block 1308, identifying a memory address to write the compressed data to, based on the unused memory pointer.

As further shown in FIG. 13, method 1300 may include, at block 1310, sending the memory address to a direct memory access module.

Method 1300 may include additional implementations, such as any single implementation or any combination of implementations described below and/or in connection with one or more other processes described elsewhere herein.

In some aspects, method 1300 includes writing the compressed data to the memory address from the direct memory access module.

In some aspects, method 1300 includes pre-allocating one or more memory slabs for one or more of the plurality of class sizes, including the class size and the first memory slab, and sending first memory pointers for the first memory slab for each of the plurality of class sizes to a memory allocator module.

In some aspects, the pre-allocating comprises allocating contiguous regions for each class size. It will be appreciated that as used herein the term “contiguous regions” can include interspersed metadata, in some aspects. Accordingly, in some aspects, each class size is not necessarily stored back to back, with no intervening data.

In some aspects, method 1300 includes pre-allocating a second memory slab for one or more of the plurality of class sizes, and sending second memory pointers for the second memory slab for one or more of the plurality of class sizes to the memory allocator module.

In some aspects, the unused memory pointer for the first memory slab for the class size was identified in response to identifying that there is no unused memory pointer for the second memory slab for the class size.

In some aspects, method 1300 includes generating the compressed data using a compression algorithm, and writing the compressed data to the at least one output buffer.

In some aspects, method 1300 includes writing the compressed data from the at least one output buffer to a memory in response to determining the size of compressed data exceeds a size of the at least one output buffer, a slab of the right size class cannot be obtained within a designated time, there is no allocated memory pointer for the size of the compressed data, or basing on the class size, there is no unused memory pointer.

In some aspects, method 1300 includes sending memory slab status data to a slab allocator module.

In some aspects, the memory slab status data is configured to indicate to the slab allocator module a use status of the memory slab for the class size.

Although FIG. 13 shows example blocks of method 1300, in some implementations, method 1300 may include additional blocks, fewer blocks, different blocks, or differently arranged blocks than those depicted in FIG. 13. Additionally, or alternatively, two or more of the blocks of method 1300 may be performed in parallel.

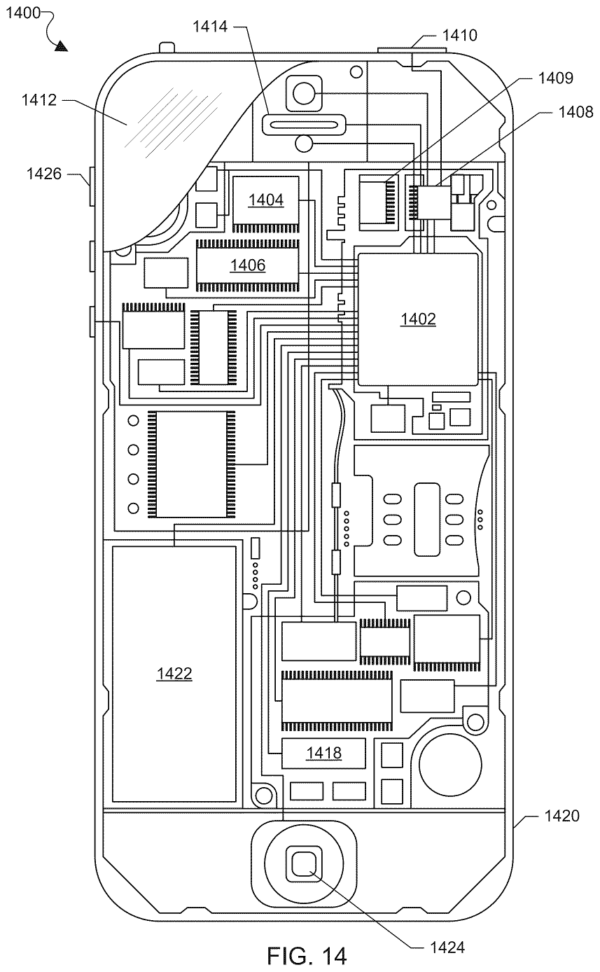

A system in accordance with the various aspects (including, but not limited to, aspects described above with reference to FIGS. 1-13) may be implemented in a wide variety of computing systems including mobile computing devices, an example of which suitable for use with the various aspects is illustrated in FIG. 14. The mobile computing device 1400 may include a processor 1402 coupled to a touchscreen controller 1404 and an internal memory 1406. The processor 1402 may be one or more multicore integrated circuits designated for general or specific processing tasks. The internal memory 1406 may be volatile or non-volatile memory, and may also be secure and/or encrypted memory, unsecure and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 1404 and the processor 1402 may also be coupled to a touchscreen panel 1412, such as a resistive-sensing touchscreen, capacitive-sensing touchscreen, infrared sensing touchscreen, etc. Additionally, the display of the mobile computing device 1400 need not have touch screen capability.

The mobile computing device 1400 may have one or more radio signal transceivers 1408 (e.g., Peanut, Bluetooth®, ZigBee®, Wi-Fi®, RF radio) and antennae 1410, for sending and receiving communications, coupled to each other and/or to the processor 1402. The processor 1402 may also be coupled to a cellular network wireless modem 1409 that enables communication via a cellular network (e.g., a 5G network) via the antenna 1410. The transceivers 1408 and antennae 1410 may be used with the above-mentioned circuitry to implement the various wireless transmission protocol stacks and interfaces.

The mobile computing device 1400 may include a peripheral device connection interface 1418 coupled to the processor 1402. The peripheral device connection interface 1418 may be singularly configured to accept one type of connection, or may be configured to accept various types of physical and communication connections, common or proprietary, such as Universal Serial Bus (USB), FireWire, Thunderbolt, or PCIe. The peripheral device connection interface 1418 may also be coupled to a similarly configured peripheral device connection port (not shown).

The mobile computing device 1400 may also include speakers 1414 for providing audio outputs. The mobile computing device 1400 may also include a housing 1420, constructed of a plastic, metal, or a combination of materials, for containing all or some of the components described herein. The mobile computing device 1400 may include a power source 1422 coupled to the processor 1402, such as a disposable or rechargeable battery. The rechargeable battery may also be coupled to the peripheral device connection port to receive a charging current from a source external to the mobile computing device 1400. The mobile computing device 1400 may also include a physical button 1424 for receiving user inputs. The mobile computing device 1400 may also include a power button 1426 for turning the mobile computing device 1400 on and off.

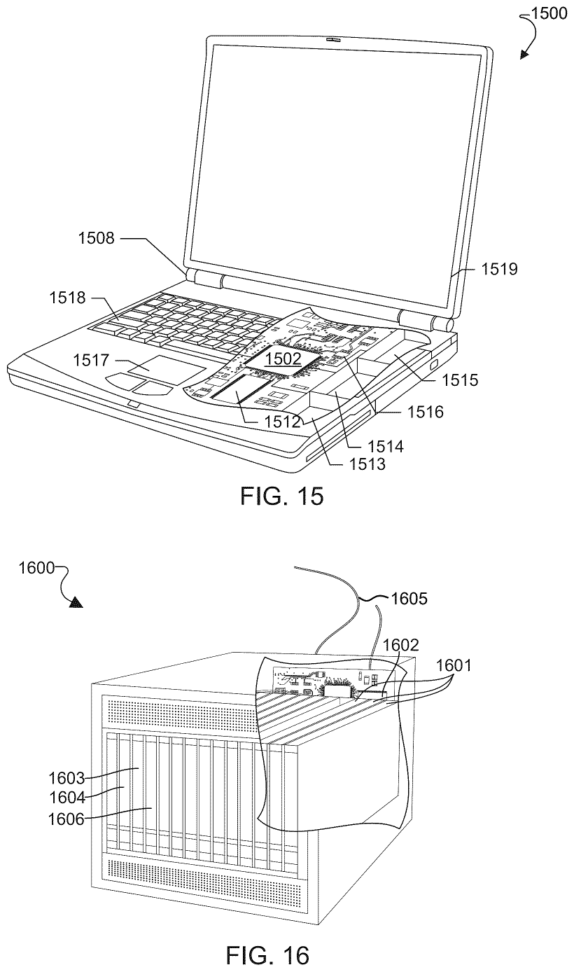

A system in accordance with the various aspects (including, but not limited to, aspects described above with reference to FIGS. 1-13) may be implemented in a wide variety of computing systems including a laptop computer 1500, an example of which is illustrated in FIG. 15. Many laptop computers include a touchpad 1517 that serves as the computer's pointing device, and thus may receive drag, scroll, and flick gestures similar to those implemented on computing devices equipped with a touch screen display and described above. A laptop computer 1500 will typically include a processor 1502 coupled to volatile memory 1512 and a large capacity nonvolatile memory, such as a disk drive 1513 of Flash memory. Additionally, the computer 1500 may have one or more antenna 1508 for sending and receiving electromagnetic radiation that may be connected to a wireless data link and/or cellular telephone transceiver 1516 coupled to the processor 1502. The computer 1500 may also include a floppy disc drive 1514 and a compact disc (CD) drive 1515 coupled to the processor 1502. In a notebook configuration, the computer housing includes the touchpad 1517, the keyboard 1518, and the display 1519 all coupled to the processor 1502. Other configurations of the computing device may include a computer mouse or trackball coupled to the processor (e.g., via a USB input) as are well known, which may also be used in conjunction with the various aspects.

A system in accordance with the various aspects (including, but not limited to, aspects described above with reference to FIGS. 1-13) may also be implemented in fixed computing systems, such as any of a variety of commercially available servers. An example server 1600 is illustrated in FIG. 16. Such a server 1600 includes one or more multicore processor assemblies 1601 coupled to volatile memory 1602 and a large capacity nonvolatile memory, such as a disk drive 1604. As illustrated in FIG. 15, multicore processor assemblies 1601 may be added to the server 1600 by inserting them into the racks of the assembly. The server 1600 may also include a floppy disc drive, compact disc (CD) or digital versatile disc (DVD) disc drive 1606 coupled to the multicore processor assemblies 1601. The server 1600 may also include network access ports 1603 coupled to the multicore processor assemblies 1601 for establishing network interface connections with a network 1605, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include the example systems or devices discussed in the following paragraphs implemented as a non-transitory processor-readable storage medium having stored thereon processor-executable instructions configured to cause a processor of a computing device to perform the operations of the example systems, devices, or methods.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method performed by a memory footprint compression system of a computing device for writing compressed data to memory, comprising: receiving a size of compressed data stored in at least one output buffer; identifying a class size based on the size of the compressed data; identifying an unused memory pointer for a first memory slab based on the class size, wherein the first memory slab is pre-allocated; identifying a memory address to write the compressed data to, based on the unused memory pointer; and sending the memory address to a direct memory access module.

Clause 2. The method of clause 1, further comprising: writing the compressed data to the memory address from the direct memory access module.

Clause 3. The method of any of clauses 1 to 2, further comprising: pre-allocating one or more memory slabs for one or more of the plurality of class sizes, including the class size and the first memory slab; and sending first memory pointers for the first memory slab for each of the plurality of class sizes to a memory allocator module.

Clause 4. The method of clause 3, wherein the pre-allocating comprises: allocating contiguous regions for each class size.

Clause 5. The method of any of clauses 3 to 4, further comprising: pre-allocating a second memory slab for one or more of the plurality of class sizes; and sending second memory pointers for the second memory slab for one or more of the plurality of class sizes to the memory allocator module.

Clause 6. The method of clause 5, wherein the unused memory pointer for the first memory slab for the class size was identified in response to identifying that there is no unused memory pointer for the second memory slab for the class size.

Clause 7. The method of any of clauses 1 to 6, further comprising: generating the compressed data using a compression algorithm; and writing the compressed data to the at least one output buffer.

Clause 8. The method of any of clauses 1 to 7, further comprising: writing the compressed data from the at least one output buffer to a memory in response to determining: the size of compressed data exceeds a size of the at least one output buffer, a slab of the right size class cannot be obtained within a designated time, there is no allocated memory pointer for the size of the compressed data, or based on the class size, there is no unused memory pointer.

Clause 9. The method of any of clauses 1 to 8, further comprising sending memory slab status data to a slab allocator module.

Clause 10. The method of clause 9, wherein the memory slab status data is configured to indicate to the slab allocator module a use status of the memory slab for the class size.

Clause 11. A computing device having a memory footprint compression system, comprising: one or more memories; and one or more processors communicatively coupled to the one or more memories, the one or more processors, either alone or in combination, configured to: receive a size of compressed data stored in at least one output buffer; identify a class size based on the size of the compressed data; identify an unused memory pointer for a first memory slab based on the class size, wherein the first memory slab is pre-allocated; identify a memory address to write the compressed data to, based on the unused memory pointer; and send the memory address to a direct memory access module.

Clause 12. The computing device of clause 11, wherein the one or more processors, either alone or in combination, are further configured to: write the compressed data to the memory address from the direct memory access module.

Clause 13. The computing device of any of clauses 11 to 12, wherein the one or more processors, either alone or in combination, are further configured to: pre-allocate one or more memory slabs for one or more of the plurality of class sizes, including the class size and the first memory slab; and send first memory pointers for the first memory slab for each of the plurality of class sizes to a memory allocator module.

Clause 14. The computing device of clause 13, wherein the pre-allocating comprises: allocate contiguous regions for each class size.

Clause 15. The computing device of any of clauses 13 to 14, wherein the one or more processors, either alone or in combination, are further configured to: pre-allocate a second memory slab for one or more of the plurality of class sizes; and send second memory pointers for the second memory slab for one or more of the plurality of class sizes to the memory allocator module.

Clause 16. The computing device of clause 15, wherein the unused memory pointer for the first memory slab for the class size was identified in response to identifying that there is no unused memory pointer for the second memory slab for the class size.

Clause 17. The computing device of any of clauses 11 to 16, wherein the one or more processors, either alone or in combination, are further configured to: generate the compressed data using a compression algorithm; and write the compressed data to the at least one output buffer.

Clause 18. The computing device of any of clauses 11 to 17, wherein the one or more processors, either alone or in combination, are further configured to: write the compressed data from the at least one output buffer to a memory in response to a determination that: the size of compressed data exceeds a size of the at least one output buffer, a slab of the right size class cannot be obtained within a designated time, there is no allocated memory pointer for the size of the compressed data, or based on the class size, there is no unused memory pointer.

Clause 19. The computing device of any of clauses 11 to 18, wherein the one or more processors, either alone or in combination, are further configured to send memory slab status data to a slab allocator module.

Clause 20. The computing device of clause 19, wherein the memory slab status data is configured to indicate to the slab allocator module a use status of the memory slab for the class size.

Clause 21. A method performed by a memory footprint compression system of a computing device for writing compressed data to memory, comprising: receiving a size of compressed data stored in at least one output buffer; identifying a class size of a memory slab based on the size of the compressed data; identifying an unused memory pointer for a first memory slab for the class size; identifying a memory address to which to write the compressed data based on the unused memory pointer; and sending the memory address to a direct memory access module.

Clause 22. The method of clause 21, further comprising identifying that the first memory slab for the class size is pre-allocated, wherein identifying the unused memory pointer for the first memory slab for the class size comprises identifying the unused memory pointer for the first memory slab for the class size in response to identifying that the first memory slab for the class size is pre-allocated.

Clause 23. The method of any of clauses 21 to 22, further comprising identifying that there is no unused memory pointer for a second memory slab for the class size, wherein identifying the unused memory pointer for the first memory slab for the class size comprises identifying the unused memory pointer for the first memory slab for the class size in response to identifying that there is no unused memory pointer for the second memory slab for the class size.

Clause 24. The method of any of clauses 21 to 23, further comprising sending a memory slab status data to a slab allocator module.

Clause 25. The method of clause 24, wherein the memory slab status data is configured to indicate to the slab allocator module a use status of the memory slab for the class size.

Clause 26. The method of any of clauses 21 to 25, further comprising: receiving memory pointers for at least one memory slab for each of a plurality of class sizes from a slab allocator module, wherein the at least one memory slab for each of the plurality of class sizes includes the first memory slab for the class size; and storing the memory pointers for the at least one memory slab for each of the plurality of class sizes, wherein the memory pointers for the at least one memory slab for each of the plurality of class sizes include the unused memory pointer for the first memory slab for the class size.

Clause 27. The method of clause 26, further comprising: receiving memory pointers for a second memory slab for at least one class size from the slab allocator module, wherein the plurality of class sizes includes the at least one class size; and storing the memory pointers for the second memory slab for the at least one class size.

Clause 28. The method of clause 27, further comprising sending a memory slab status data to the slab allocator module, wherein receiving the memory pointers for the second memory slab for the at least one class size from the slab allocator module comprises receiving the memory pointers for the second memory slab for the at least one class size from the slab allocator module following sending the memory slab status data to the slab allocator module.

Clause 29. A method performed by a memory footprint compression system of a computing device for writing compressed data to memory, comprising: pre-allocating at least one memory slab for each of a plurality of class sizes; and sending memory pointers for the at least one memory slab for each of the plurality of class sizes to a memory allocator module.

Clause 30. The method of clause 29, further comprising: receiving a memory slab status for a first memory slab for a first class size from the memory allocator module; identifying to pre-allocate a second memory slab for the first class size based on the memory slab status for the first memory slab for the first class size; and in response to identifying to pre-allocate the second memory slab for the first class size: pre-allocating the second memory slab for the first class size; and sending memory pointers for the second memory slab for the first class size to the memory allocator module.

Clause 31. The method of any of clauses 29 to 30, wherein: pre-allocating the at least one memory slab for each of the plurality of class sizes comprises pre-allocating at least two memory slabs for each of the plurality of class sizes; and sending the memory pointers for the at least one memory slab for each of the plurality of class sizes to the memory allocator module comprises sending memory pointers for a first memory slab for each of the plurality of class sizes to the memory allocator module, the method further comprising sending memory pointers for a second memory slab for at least one class size to the memory allocator.

Clause 32. The method of clause 31, further comprising: receiving a memory slab status for the first memory slab for the at least one class size from the memory allocator module; determining to send memory pointers for the second memory slab for the at least one class size based on the memory slab status for the first memory slab for the at least one class size; and sending the memory pointers for the second memory slab for the at least one class size to the memory allocator module in response to identifying to send the memory pointers for the second memory slab for the at least one class size.

Clause 33. A method performed by a memory footprint compression system of a computing device for writing compressed data to memory, comprising: receiving a size of compressed data stored in at least one output buffer; determining to not continue single pass memory footprint compression for the compressed data based on the size of the compressed data; and sending a memory slab status data to a slab allocator module configured to indicate to the slab allocator module to transition to two pass memory footprint compression in response to identifying to not continue single pass memory footprint compression for the compressed data.

Clause 34. The method of clause 33, further comprising identifying a class size for a pre-allocated memory slab large enough to store the compressed data of the size of the compressed data, wherein determining to not continue single pass memory footprint compression for the compressed data based on the size of the compressed data comprises determining to not continue single pass memory footprint compression based on availability of the pre-allocated memory slab for the class size large enough to store the compressed data of the size of the compressed data.

Clause 35. The method of any of clauses 33 to 34, further comprising identifying a class size for a pre-allocated memory slab large enough to store the compressed data of the size of the compressed data, wherein determining to not continue single pass memory footprint compression for the compressed data based on the size of the compressed data comprises determining to not continue single pass memory footprint compression based on a time to write the compressed data to the pre-allocated memory slab for the class size large enough to store the compressed data of the size of the compressed data.

Clause 36. A method performed by a memory footprint compression system of a computing device for writing compressed data to memory, comprising: compressing data generating compressed data; writing the compressed data to at least one output buffer; and writing the compressed data from the at least one output buffer to a memory in response to determining that a size of the compressed data exceeds a compressed data size threshold.

Clause 37. The method of clause 36, wherein the compressed data size threshold represents a capacity of the at least one output buffer.

Clause 38. The method of any of clauses 36 to 37, wherein the compressed data size threshold represents a largest class size for a pre-allocated memory slab.

Clause 39. The method of any of clauses 36 to 38, further comprising: compressing subsequent data generating subsequent compressed data; and writing the subsequent compressed data to the memory in response to identifying that the size of the compressed data exceeds the compressed data size threshold.

Clause 40. The method of clause 39, further comprising writing the subsequent compressed data to the at least one output buffer, wherein writing the subsequent compressed data to the memory in response to determining that the size of the compressed data exceeds the compressed data size threshold comprises writing the subsequent compressed data from the at least one output buffer to the memory.

Clause 41. An apparatus comprising one or more memories, and one or more processors communicatively coupled to the one or more memories, the one or more memories and the one or more processors configured to perform a method according to any of clauses 1 to 10 and 21 to 40.

Clause 42. An apparatus comprising means for performing a method according to any of clauses 1 to 10 and 21 to 40.

Clause 43. A non-transitory computer-readable medium storing computer-executable instructions, the computer-executable comprising at least one instruction for causing a computer or processor to perform a method according to any of clauses 1 to 10 and 21 to 40.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method performed by a memory footprint compression system of a computing device for writing compressed data to memory, comprising:
receiving a size of compressed data stored in at least one output buffer;
identifying a class size based on the size of the compressed data;
identifying an unused memory pointer for a first memory slab based on the class size, wherein the first memory slab is pre-allocated;
identifying a memory address to write the compressed data to, based on the unused memory pointer; and
sending the memory address to a direct memory access module.

2. The method of claim 1, further comprising:
writing the compressed data to the memory address from the direct memory access module.

3. The method of claim 1, further comprising:
pre-allocating one or more memory slabs for one or more of a plurality of class sizes, including the class size and the first memory slab; and
sending first memory pointers for the first memory slab for each of the plurality of class sizes to a memory allocator module.

4. The method of claim 3, wherein the pre-allocating comprises:
allocating contiguous regions for each class size.

5. The method of claim 3, further comprising:
pre-allocating a second memory slab for one or more of the plurality of class sizes; and
sending second memory pointers for the second memory slab for one or more of the plurality of class sizes to the memory allocator module.

6. The method of claim 5, wherein the unused memory pointer for the first memory slab for the class size was identified in response to identifying that there is no unused memory pointer for the second memory slab for the class size.

7. The method of claim 1, further comprising:
generating the compressed data using a compression algorithm; and
writing the compressed data to the at least one output buffer.

8. The method of claim 1, further comprising:
writing the compressed data from the at least one output buffer to a memory in response to determining:
the size of compressed data exceeds a size of the at least one output buffer,
a slab of a right size class cannot be obtained within a designated time,
there is no allocated memory pointer for the size of the compressed data, or
based on the class size, there is no unused memory pointer.

9. The method of claim 1, further comprising sending memory slab status data to a slab allocator module.

10. The method of claim 9, wherein the memory slab status data is configured to indicate to the slab allocator module a use status of the memory slab for the class size.

11. A computing device having a memory footprint compression system, comprising:
one or more memories; and
one or more processors communicatively coupled to the one or more memories, the one or more processors, either alone or in combination, configured to:
receive a size of compressed data stored in at least one output buffer;
identify a class size based on the size of the compressed data;
identify an unused memory pointer for a first memory slab based on the class size, wherein the first memory slab is pre-allocated;
identify a memory address to write the compressed data to, based on the unused memory pointer; and
send the memory address to a direct memory access module.

12. The computing device of claim 11, wherein the one or more processors, either alone or in combination, are further configured to:
write the compressed data to the memory address from the direct memory access module.

13. The computing device of claim 11, wherein the one or more processors, either alone or in combination, are further configured to:
pre-allocate one or more memory slabs for one or more of a plurality of class sizes, including the class size and the first memory slab; and
send first memory pointers for the first memory slab for each of the plurality of class sizes to a memory allocator module.

14. The computing device of claim 13, wherein the pre-allocating comprises:
allocate contiguous regions for each class size.

15. The computing device of claim 13, wherein the one or more processors, either alone or in combination, are further configured to:
pre-allocate a second memory slab for one or more of the plurality of class sizes; and
send second memory pointers for the second memory slab for one or more of the plurality of class sizes to the memory allocator module.

16. The computing device of claim 15, wherein the unused memory pointer for the first memory slab for the class size was identified in response to identifying that there is no unused memory pointer for the second memory slab for the class size.

17. The computing device of claim 11, wherein the one or more processors, either alone or in combination, are further configured to:
generate the compressed data using a compression algorithm; and
write the compressed data to the at least one output buffer.

18. The computing device of claim 11, wherein the one or more processors, either alone or in combination, are further configured to:
write the compressed data from the at least one output buffer to a memory in response to a determination that:
the size of compressed data exceeds a size of the at least one output buffer,
a slab of a right size class cannot be obtained within a designated time,
there is no allocated memory pointer for the size of the compressed data, or
based on the class size, there is no unused memory pointer.

19. The computing device of claim 11, wherein the one or more processors, either alone or in combination, are further configured to send memory slab status data to a slab allocator module.

20. The computing device of claim 19, wherein the memory slab status data is configured to indicate to the slab allocator module a use status of the memory slab for the class size.
